(19) United States
(12) Patent Application Publication
(10) Pub. No.: US 2026/0230591 A1
(43) Pub. Date: Aug. 6, 2026

(54) LOW POWER CAMERA SENSING FOR ARTIFICIAL INTELLIGENCE (AI) ASSISTANCE

(71) Applicant: QUALCOMM Incorporated, San Diego, CA (US)

(72) Inventors: Wesley James HOLLAND, Encinitas, CA (US); Ziad ASGHAR, San Diego, CA (US)

(21) Appl. No.: 19/425,974

(22) Filed: Dec. 18, 2025

Related U.S. Application Data
(60) Provisional application No. 63/752,604, filed on Jan. 31, 2025.

(51) Int. Cl. H04N 7/18; G06V 10/70; G06V 10/82; G06V 20/52

(52) U.S. Cl. CPC H04N 7/188; G06V 10/768; G06V 10/82; G06V 20/52

(57) ABSTRACT

Systems and techniques are described for artificial intelligence (AI) assistance. For example, a computing device associated with a user can obtain, from one or more image sensors of the device, a plurality of images of a scene. The computing device can determine, based on at least one of the plurality of images or a previous event occurrence, one or more contexts for the scene. The computing device can determine, based on the one or more contexts, one or more events. The computing device can monitor, by the one or more image sensors, the scene for the one or more events.

### CROSS-REFERENCE TO RELATED APPLICATIONS

This application claims the benefit of U.S. Provisional Application No. 63/752,604, filed Jan. 31, 2025, which is hereby incorporated by reference in its entirety and for all purposes.

### FIELD

The present disclosure generally relates to artificial intelligence (AI) assistance. For example, aspects of the present disclosure relate to system designs and methods for low power camera sensing for artificial intelligence (AI) assistance.

### BACKGROUND

Electronic devices are increasingly equipped with camera hardware to capture images and/or videos for consumption. For example, a computing device can include a camera (e.g., a mobile device such as a mobile telephone or smartphone including one or more cameras) to allow the computing device to capture a video or image of a scene, a person, an object, etc. The image or video can be captured and processed by the computing device (e.g., a mobile device, an IP camera, extended reality device, connected device, etc.) and stored or output for consumption (e.g., displayed on the device and/or another device). In some cases, the image or video can be further processed for effects (e.g., compression, image enhancement, image restoration, scaling, framerate conversion, etc.) and/or certain applications such as computer vision, extended reality (e.g., augmented reality, virtual reality, and the like), object detection, image recognition (e.g., face recognition, object recognition, scene recognition, etc.), feature extraction, authentication, and automation, among others.

In some cases, an electronic device can process images to detect objects, faces, and/or any other items captured by the images. The object detection can be useful for various applications such as, for example, artificial intelligence assistance, authentication, automation, gesture recognition, surveillance, extended reality, computer vision, among others. In some examples, the electronic device can implement a lower-power or “always-on” (AON) camera that persistently or periodically operates to automatically detect certain objects in an environment. The lower-power camera can be implemented for a variety of use cases such as, for example, persistent gesture detection, persistent object (e.g., face/person, animal, vehicle, device, plane, etc.) detection, persistent object scanning (e.g., quick response (QR) code scanning, barcode scanning, etc.), persistent facial recognition for authentication, etc.

Artificial intelligence assistants, associated with the electronic device, can have access to rich, always-available visual context derived from these captured images (e.g., captured by a low power camera, such as an AON camera, within the device). The current paradigm for this usage of visual context is to provide a snapshot (an image) alongside the verbal query from a user associated with the electronic device. However, in some cases, some context may be missed by just using a single snapshot.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for artificial intelligence (AI) assistance. In some aspects, an apparatus for AI assistance is provided. The apparatus includes at least one memory and at least one processor coupled to the at least one memory and configured to: obtain, from one or more image sensors of a device associated with a user, a plurality of images of a scene; determine, based on at least one of the plurality of images or a previous event occurrence, one or more contexts for the scene; determine, based on the one or more contexts, one or more events; and monitor, using the one or more image sensors, the scene for the one or more events.

In some aspects, a method for AI assistance is provided. The method includes: obtaining, by one or more image sensors of a device associated with a user, a plurality of images of a scene; determining, based on at least one of the plurality of images or a previous event occurrence, one or more contexts for the scene; determining, based on the one or more contexts, one or more events; and monitoring, by the one or more image sensors, the scene for the one or more events.

In some aspects, a non-transitory computer-readable medium is provided having stored thereon instructions that, when executed by at least one processor, cause the at least one processor to: obtain, from one or more image sensors of a device associated with a user, a plurality of images of a scene; determine, based on at least one of the plurality of images or a previous event occurrence, one or more contexts for the scene; determine, based on the one or more contexts, one or more events; and monitor, by the one or more image sensors, the scene for the one or more events.

In some aspects, an apparatus for AI assistance is provided. The apparatus includes: means for obtaining, from one or more image sensors of a device associated with a user, a plurality of images of a scene; means for determining, based on at least one of the plurality of images or a previous event occurrence, one or more contexts for the scene; means for determining, based on the one or more contexts, one or more events; and means for monitoring the scene for the one or more events.

In some aspects, an apparatus for AI assistance is provided. The apparatus includes at least one memory and at least one processor coupled to the at least one memory and configured to: obtain, from one or more image sensors of a device associated with a user, a plurality of images of a scene, wherein each image of the plurality of images is obtained at a respective time; determine, based on the plurality of images, one or more contexts for the scene; encode, based on the one or more contexts, each image of the plurality of images to produce a respective image encoding for each of the plurality of images; receive a query from the user; generate a prompt based on the query and the one or more contexts; encode the prompt to produce a prompt encoding; generate, based on the respective image encodings and the prompt encoding, a token; and determine, based on decoding the token, an answer to the query.

In some aspects, a method for AI assistance is provided. The method includes: obtaining, by one or more image sensors of a device associated with a user, a plurality of images of a scene, wherein each image of the plurality of images is obtained at a respective time; determining, by one or more processors of the device based on the plurality of images, one or more contexts for the scene; encoding, by the one or more processors based on the one or more contexts, each image of the plurality of images to produce a respective image encoding for each of the plurality of images; receiving, by the one or more processors, a query from the user; generating, by the one or more processors, a prompt based on the query and the one or more contexts; encoding, by the one or more processors, the prompt to produce a prompt encoding; generating, by the one or more processors based on the respective image encodings and the prompt encoding, a token; and determining, by the one or more processors based on decoding the token, an answer to the query.

In some aspects, a non-transitory computer-readable medium is provided having stored thereon instructions that, when executed by at least one processor, cause the at least one processor to: obtain, from one or more image sensors of a device associated with a user, a plurality of images of a scene, wherein each image of the plurality of images is obtained at a respective time; determine, based on the plurality of images, one or more contexts for the scene; encode, based on the one or more contexts, each image of the plurality of images to produce a respective image encoding for each of the plurality of images; receive a query from the user; generate a prompt based on the query and the one or more contexts; encode the prompt to produce a prompt encoding; generate, based on the respective image encodings and the prompt encoding, a token; and determine, based on decoding the token, an answer to the query.

In some aspects, an apparatus for AI assistance is provided. The apparatus includes: means for obtaining, from one or more image sensors of a device associated with a user, a plurality of images of a scene, wherein each image of the plurality of images is obtained at a respective time; means for determining, based on the plurality of images, one or more contexts for the scene; means for encoding, based on the one or more contexts, each image of the plurality of images to produce a respective image encoding for each of the plurality of images; means for receiving a query from the user; means for generating a prompt based on the query and the one or more contexts; means for encoding the prompt to produce a prompt encoding; means for generating, based on the respective image encodings and the prompt encoding, a token; and means for determining, based on decoding the token, an answer to the query.

Some aspects include a device having a processor (or multiple processors) configured to perform one or more operations of any of the methods summarized above. In some cases, the processor(s) can include a neural processing unit (NPU), a neural signal processor (NSP), a digital signal processor (DSP), a graphics processing unit (GPU), a central processing unit (CPU), any combination thereof, and/or other processor(s). Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example of an electronic device used to determine event data and control one or more components and/or operations of the electronic device based on the event data, in accordance with some aspects of the disclosure.

FIG. 2A and FIG. 2B are diagrams illustrating example system processes for mapping events associated with an environment and controlling settings of a device based on mapped events, in accordance with some aspects of the disclosure.

FIG. 3A and FIG. 3B are diagrams illustrating example processes for updating an event map, in accordance with some aspects of the disclosure.

FIG. 4 is a diagram illustrating examples of use cases for an always sensing camera (e.g., an always on camera) in a device, in accordance with some aspects of the disclosure.

FIG. 5 is a diagram illustrating an example of a system for a device with an always sensing camera (e.g., an always on camera), in accordance with some aspects of the disclosure.

FIG. 6 is a diagram illustrating an example of a process for six (6) degrees of freedom (DOF) tracking, in accordance with some aspects of the disclosure.

FIG. 7 is a diagram illustrating an example of a processing timeline for artificial intelligence assistance that includes a time to first token (TTFT), in accordance with some aspects of the disclosure.

FIG. 8 is a diagram illustrating an example of a wearable device (e.g., an XR device) capable of capturing images and determining visual context from the images, in accordance with some aspects of the disclosure.

FIG. 9 is a diagram illustrating an example of a processing timeline for artificial intelligence (AI) assistance showing an image captured and encoded after completion of a user prompt, in accordance with some aspects of the disclosure.

FIG. 10 is a diagram illustrating an example of a process for AI assistance, in accordance with some aspects of the disclosure.

FIG. 11 is a diagram illustrating another example of a process for AI assistance, in accordance with some aspects of the disclosure.

FIG. 12 is a flow diagram illustrating an example of process for AI assistance, in accordance with some aspects of the disclosure.

FIG. 13 is a diagram illustrating a comparison of example processing timelines for AI assistance, in accordance with some aspects of the disclosure.

FIG. 14 is a diagram illustrating an example of a system for context trigger selection of events to be monitored by an always sensing camera (e.g., an always on camera) in a device, in accordance with some aspects of the disclosure.

FIG. 15 is a diagram illustrating an example of a system for context trigger selection of events to be monitored by an always sensing camera (e.g., an always on camera) in a device, where the system uses AI to determine the events to monitor, in accordance with some aspects of the disclosure.

FIG. 16 is a diagram illustrating an example of a system for context trigger selection of events to be monitored by an always sensing camera (e.g., an always on camera) in a device, where the system uses 6 DOF tracking to determine the events to monitor, in accordance with some aspects of the disclosure.

FIG. 17 is a flow diagram illustrating an example of a process for low power camera sensing for AI assistance, in accordance with some aspects of the disclosure.

FIG. 18 is a flow diagram illustrating another example of a process low power camera sensing for AI assistance, in accordance with some aspects of the disclosure.

FIG. 19 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Electronic devices (e.g., mobile phones, wearable devices (e.g., smart watches, smart bracelets, smart glasses, etc.), tablet computers, extended reality (XR) devices (e.g., virtual reality (VR) devices, augmented reality (AR) devices, mixed reality (MR) devices, and the like), connected devices, laptop computers, etc.) can implement cameras to detect and/or recognize events of interest. For example, electronic devices can implement cameras that can operate at a reduced power mode and/or can operate as lower-power cameras (e.g., lower than a capacity of the cameras and/or any other cameras on the electronic device) to detect and/or recognize events of interest on demand, an on-going, or a periodic basis. In some examples, a lower-power camera can include a camera operating in a reduced or lower power mode/consumption (e.g., relative to the power mode/consumption capabilities of the camera and/or another camera with higher power mode/consumption capabilities). In some cases, a lower-power camera can employ lower-power settings (e.g., lower power modes, lower power operations, lower power hardware, lower power camera pipeline, etc.) to allow for persistent imaging with limited or reduced power consumption as compared to other cameras and/or camera pipelines, such as a main camera and/or main camera pipeline. The lower-power settings employed by the lower-power camera can include, for example and without limitation, a lower resolution, a lower amount of image sensors (and/or an image sensor(s) having a lower power consumption than other image sensors on the electronic device), a lower framerate, on-chip static random-access memory (SRAM) rather than dynamic random-access memory (DRAM) which may generally draw more power than SRAM, island voltage rails, oscillators (e.g., rather than phase lock loops (PLLs) which may have a higher power draw) for lock sourcing, and/or other hardware/software components/settings that result in lower power consumption.

As noted above, the cameras can be used to detect events of interest. Example events of interest can include gestures (e.g., hand gestures, etc.), an action (e.g., by a device, person, and/or animal), a presence or occurrence of one or more objects, etc. An object associated with an event of interest can include and/or refer to, for example and without limitation, a face, a hand, one or more fingers, a portion of a human body, a code (e.g., a quick response (QR) code, a barcode, etc.), a document, a scene or environment, a link, a machine-readable code, etc. The lower-power cameras can implement lower-power hardware and/or energy efficient image processing software used to detect events of interest. The lower-power cameras can remain on or “wake up” to watch movement and/or objects in a scene and detect events in the scene while using less battery power than other devices such as higher power/resolution cameras.

For example, a camera can watch movement and/or activity in a scene to discover objects. In some examples, the camera can employ lower-power settings for lower or limited power consumption as previously described and as compared to the camera or another camera employing higher-power settings. To illustrate, an XR device can implement a camera that periodically discovers an XR controller and/or other tracked objects, a mobile phone can implement a camera that periodically checks for a code (e.g., QR code) or document to scan, a smart home assistant can implement a camera that periodically checks for a user presence, etc. Upon discovering an object, the camera can trigger one or more actions such as, for example, object detection, object recognition, authentication (e.g., facial authentication, etc.), and/or image processing tasks, among other actions. In some cases, the cameras can “wake up” other devices and/or components such as other cameras, sensors, processing hardware, etc.

As mentioned, artificial intelligence (AI) assistants, associated with the electronic device, can have access to rich, always-available visual context derived from these captured images (e.g., captured by a low power camera, such as an AON camera, within the device). The current paradigm for this usage of visual context is to provide a snapshot (an image) alongside the verbal query from a user associated with the electronic device. However, in some cases, some context can be missed by just using a snapshot. For example, an object may be fast moving and, as such, the object is not able to be captured within the snapshot. For another example, the user's head (wearing the electronic device with the camera) may have moved in an opposite direction of the object and, as such, the object is not captured within the snapshot before the completion of generating a prompt for answering the query of the user.

As such, improved systems and techniques for low power camera sensing for AI assistance can be beneficial.

In one or more aspects of the present disclosure, systems, apparatuses, methods (also referred to as processes), and computer-readable media (collectively referred to herein as “systems and techniques”) are described herein that provide solutions for low power camera sensing for AI assistance.

Various aspects relate generally to artificial intelligence (AI) assistance. Some aspects more specifically relate to systems and techniques that provide solutions that leverage an low power camera (e.g., an AON camera) to monitor visual context for a prompt. In one or more examples, as known objects and/or scenes are recognized, these items are entered into a journal (e.g., log), which can be provided as prompt context for user-initiated AI assistance interactions (e.g., user queries for the AI assistant).

In one or more aspects, during operation of a method for AI assistance, one or more image sensors of a device associated with a user can obtain a plurality of images of a scene. In one or more examples, each image of the plurality of images can be obtained at a respective time. One or more processors of the device, based on the plurality of images, can determine one or more contexts for the scene. The one or more processors, based on the one or more contexts, can encode each image of the plurality of images to produce a respective image encoding for each of the images. The one or more processors can receive a query from the user. The one or more processors can generate a prompt based on the query and the one or more contexts. The one or more processors can encode the prompt to produce a prompt encoding. The one or more processors can generate, based on the respective image encodings and the prompt encoding, a token. The one or more processors can determine, based on decoding the token, an answer to the query.

In one or more examples, obtaining the plurality of images and producing the respective image encodings of each image of the plurality of images can occur prior to receiving the query. In some examples, determining the answer to the query can be further based on language within the query. In one or more examples, determining the answer to the query is can be further based on applying the language within the query to a large language model (LLM). In some examples, the one or more contexts can be stored within a log. In one or more examples, the one or more processors can remove at least one context of the one or more contexts from the log based on an expiration of time from obtaining at least one image of the plurality of images associated with the at least one context. In some examples, the log can be a vector database. In one or more examples, the one or more processors can generate, based on the prompt, a prompt embedding. In some examples, the one or more processors can perform, based on the prompt embedding, a vector search within the vector database to determine event information. In one or more examples, the one or more processors can add the event information to the prompt. In some examples, the device can be an extended reality (XR) device. In one or more examples, the device can be a head-mounted device. In one or more examples, the one or more images sensors can include one or more always-on (AON) image sensors.

In some aspects, during operation of a method for AI assistance, one or more image sensors of a device associated with a user can obtain a plurality of images of a scene. One or more processors can determine, based on one or more images of the plurality of images and/or a previous event occurrence, one or more contexts for the scene. The one or more processors can determine, based on the one or more contexts, one or more events. The one or more image sensors can monitor the scene for the one or more events.

In one or more examples, the one or more events can be stored within a log. In some examples, the one or more processors can load, based on the one or more events, one or more neural network models into hardware of the one or more image sensors. In one or more examples, each image of the plurality of images can be obtained at a respective time. In some examples, the one or more contexts can be in a hierarchical structure. In one or more examples, determining the one or more events can be further based on a map comprising the one or more contexts. In some examples, determining the one or more events can be further based on applying a LLM to language of the one or more contexts. In one or more examples, the one or more events can be determined by one or more processors associated with the device or located remote from the device. In some examples, determining the one or more events can be further based on a respective six (6) degrees of freedom (DOF) of each image sensor of the one or more image sensors when obtaining the one or more images of the plurality of images. In one or more examples, the one or more processors can determine, based on the one or more events, a prompt context. In some examples, the one or more processors can receive a query from a user. In one or more examples, the one or more processors can determine, based on the prompt context and the query, an answer to the query. In some examples, the one or more images sensors can include one or more always-on image sensors.

Particular aspects of the subject matter described in this disclosure can be implemented to realize one or more of the following potential advantages. In one or more examples, the systems and techniques can provide a benefit of low power camera sensing for AI assistance with a reduction in latency and computation.

Additional aspects of the present disclosure are described in more detail below. Various aspects of the systems and techniques described herein will be discussed below with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

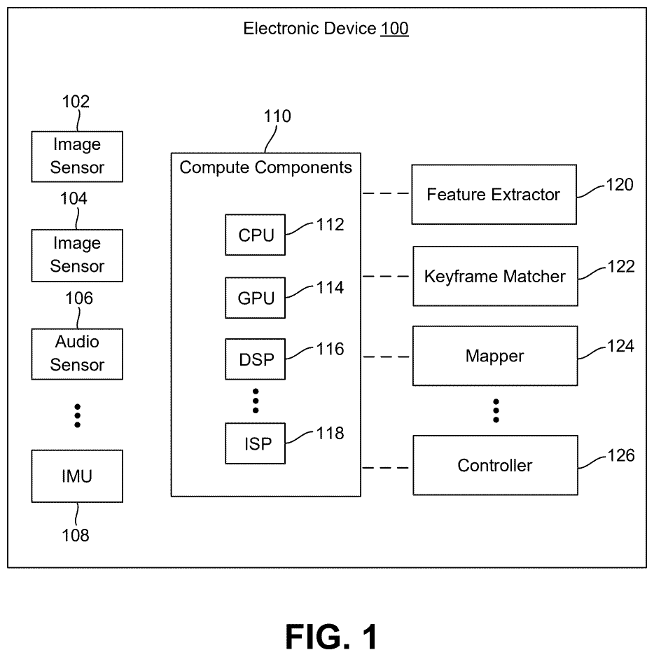

FIG. 1 is a diagram illustrating an example of an electronic device 100 used to map events and control one or more components and/or operations of the electronic device 100 based on mapped events, in accordance with some examples of the present disclosure. In some examples, the electronic device 100 can include an electronic device configured to provide one or more functionalities such as, for example, imaging functionalities, extended reality (XR) functionalities (e.g., localization/tracking, detection, classification, mapping, content rendering, etc.), image processing functionalities, device management and/or control functionalities, gaming functionalities, autonomous driving or navigation functionalities, computer vision functionalities, robotic functions, automation, computer vision, etc.

For example, in some cases, the electronic device 100 can be an XR device (e.g., a head-mounted display, a heads-up display device, smart glasses, etc.) configured to detect, localize, and map the location of the XR device, provide XR functionalities, and map events as described herein to control one or more operations/states of the XR device. In some cases, the electronic device 100 can implement one or more applications such as, for example and without limitation, an XR application, an application for managing and/or controlling components and/or operations of the electronic device 100, a smart home application, a video game application, a device control application, an autonomous driving application, a navigation application, a productivity application, a social media application, a communications application, a modeling application, a media application, an electronic commerce application, a browser application, a design application, a map application, and/or any other application.

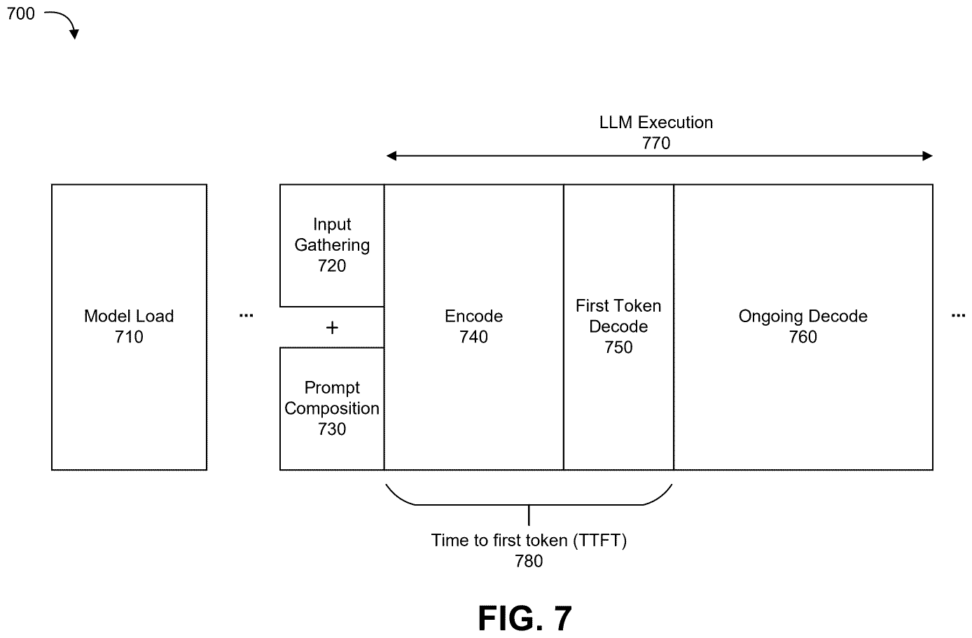

In the illustrative example shown in FIG. 1, the electronic device 100 can include one or more image sensors, such as image sensors 102 and 104, an audio sensor 106 (e.g., an ultrasonic sensor, a microphone, etc.), an inertial measurement unit (IMU) 108, and one or more compute components 110. In some cases, the electronic device 100 can optionally include one or more other/additional sensors such as, for example and without limitation, a radar, a light detection and ranging (LIDAR) sensor, a touch sensor, a pressure sensor (e.g., a barometric air pressure sensor and/or any other pressure sensor), a gyroscope, an accelerometer, a magnetometer, and/or any other sensor. In some examples, the electronic device 100 can include additional components such as, for example, a light-emitting diode (LED) device, a storage device, a cache, a communications interface, a display, a memory device, etc. An example architecture and example hardware components that can be implemented by the electronic device 100 are further described below with respect to FIG. 7.

The electronic device 100 can be part of, or implemented by, a single computing device or multiple computing devices. In some examples, the electronic device 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a laptop or notebook computer, a tablet computer, a set-top box, a smart television, a display device, a gaming console, an XR device such as an HMD, a drone, a computer in a vehicle, an IoT (Internet-of-Things) device, a smart wearable device, or any other suitable electronic device(s).

In some implementations, the image sensor 102, the image sensor 104, the audio sensor 106, the IMU 108, and/or the one or more compute components 110 can be part of the same computing device. For example, in some cases, the image sensor 102, the image sensor 104, the audio sensor 106, the IMU 108, and/or the one or more compute components 110 can be integrated with or into a camera system, a smartphone, a laptop, a tablet computer, a smart wearable device, an XR device such as an HMD, an IoT device, a gaming system, and/or any other computing device. In other implementations, the image sensor 102, the image sensor 104, the audio sensor 106, the IMU 108, and/or the one or more compute components 110 can be part of, or implemented by, two or more separate computing devices.

The one or more compute components 110 of the electronic device 100 can include, for example and without limitation, a central processing unit (CPU) 112, a graphics processing unit (GPU) 114, a digital signal processor (DSP) 116, and/or an image signal processor (ISP) 118. In some examples, the electronic device 100 can include other processors such as, for example, a computer vision (CV) processor, a neural network processor (NNP), an application-specific integrated circuit (ASIC), a field-programmable gate array (FPGA), etc. The electronic device 100 can use the one or more compute components 110 to perform various computing operations such as, for example, extended reality operations (e.g., tracking, localization, object detection, classification, pose estimation, mapping, content anchoring, content rendering, etc.), device control operations, image/video processing, graphics rendering, event mapping, machine learning, data processing, modeling, calculations, computer vision, and/or any other operations.

In some cases, the one or more compute components 110 can include other electronic circuits or hardware, computer software, firmware, or any combination thereof, to perform any of the various operations described herein. In some examples, the one or more compute components 110 can include more or less compute components than those shown in FIG. 1. Moreover, the CPU 112, the GPU 114, the DSP 116, and the ISP 118 are merely illustrative examples of compute components provided for explanation purposes.

The image sensor 102 and/or the image sensor 104 can include any image and/or video sensor or capturing device, such as a digital camera sensor, a video camera sensor, a smartphone camera sensor, an image/video capture device on an electronic apparatus such as a television or computer, a camera, etc. In some cases, the image sensor 102 and/or the image sensor 104 can be part of a camera or computing device such as a digital camera, a video camera, an IP camera, a smartphone, a smart television, a game system, etc. Moreover, in some cases, the image sensor 102 and the image sensor 104 can include multiple image sensors, such as rear and front sensor devices, and can be part of a dual-camera or other multi-camera assembly (e.g., including two camera, three cameras, four cameras, or other number of cameras).

In some examples, the image sensor 102 can be part of a camera, such as a camera that implements or is capable of implementing lower-power camera settings as previously described, and the image sensor 104 can be part of a camera, such as a camera that implements or is capable of implementing higher-power camera settings (e.g., as compared to the camera associated with the image sensor 102). In some examples, a camera associated with the image sensor 102 can implement lower-power hardware (e.g., as compared to a camera associated with the image sensor 104) and/or more energy efficient image processing software (e.g., as compared to a camera associated with the image sensor 104) used to detect events and/or process captured image data. In some cases, the camera can implement lower power settings and/or modes than the camera associated with the image sensor 104 such as, for example, a lower framerate, a lower resolution, a smaller number of image sensors, a lower-power mode, lower-power imaging mode, etc. In some examples, the camera can implement less and/or lower-power image sensors than a higher-power camera, can use lower-power memory such as on-chip static random-access memory (SRAM) rather than dynamic random-access memory (DRAM), can use island voltage rails to reduce leakage, can use ring oscillators as clock sources rather than phased-locked loops (PLLs), and/or other lower-power processing hardware/components.

In some cases, the cameras associated with image sensor 102 and/or image sensor 104 can remain on or “wake up” to watch movement and/or events in a scene and/or detect events in the scene while using less battery power than other devices such as higher power/resolution cameras. For example, a camera associated with image sensor 102 can persistently watch or wake up (for example, by a proximity sensor or wake up periodically) to watch movement and/or activity in a scene to discover objects in the scene. In some cases, upon discovering an event, the camera can trigger one or more actions such as, for example, object detection, object recognition, facial authentication, image processing tasks, among other actions. In some cases, the cameras associated with image sensor 102 and/or image sensor 104 can also “wake up” other devices such as other sensors, processing hardware, etc.

In some examples, each image sensor 102 and 104 can capture image data and generate frames based on the image data and/or provide the image data or frames to the one or more compute components 110 for processing. A frame can include a video frame of a video sequence or a still image. A frame can include a pixel array representing a scene. For example, a frame can be a red-green-blue (RGB) frame having red, green, and blue color components per pixel; a luma, chroma-red, chroma-blue (YCbCr) frame having a luma component and two chroma (color) components (chroma-red and chroma-blue) per pixel; or any other suitable type of color or monochrome picture.

In some examples, the one or more compute components 110 can perform image/video processing, event mapping, XR processing, device management/control, and/or other operations as described herein using data from the image sensor 102, the image sensor 104, the audio sensor 106, the IMU 108, and/or any other sensors and/or component. For example, in some cases, the one or more compute components 110 can perform event mapping, device control/management, tracking, localization, object detection, object classification, pose estimation, shape estimation, scene mapping, content anchoring, content rendering, image processing, modeling, content generation, gesture detection, gesture recognition, and/or other operations based on data from the image sensor 102, the image sensor 104, the audio sensor 106, the IMU 108, and/or any other component. In some examples, the one or more compute components 110 can use data from the image sensor 102, the image sensor 104, the audio sensor 106, the IMU 108, and/or any other component, to generate event data (e.g., an event map correlating detected events to particular environments and/or regions/portions of the environments) and adjust a state (e.g., power mode, setting, etc.) and/or operation of one or more components such as, for example, the image sensor 102, the image sensor 104, the audio sensor 106, the IMU 108, the one or more compute components 110, and/or any other components of the electronic device 100. In some examples, the one or more compute components 110 can detect and map events in a scene and/or control an operation/state of the electronic device 100 (and/or one or more components thereof), based on data from the image sensor 102, the image sensor 104, the audio sensor 106, the IMU 108, and/or any other component.

In some examples, the one or more compute components 110 can implement one or more software engines and/or algorithms such as, for example, a feature extractor 120, a keyframe matcher 122, a mapper 124, and a controller 126, as described herein. In some cases, the one or more compute components 110 can implement one or more additional components and/or algorithms such as a machine learning model(s), a computer vision algorithm(s), a neural network(s), and/or any other algorithm and/or component.

In some examples, the feature extractor 120 can extract visual features from one or more frames obtained by a camera device, such as a camera device associated with image sensor 102. The feature extractor 120 can implement a detector and/or algorithm to extract the visual features such as, for example and without limitation, a scale-invariant feature transform (SIFT), speeded up robust features (SURF), Oriented FAST and rotated BRIEF (ORB), and/or any other detector/algorithm.

In some examples, the keyframe matcher 122 can compare features of the one or more frames obtained by the camera device (e.g., the visual features extracted by the feature extractor 120) to features of keyframes in event data (e.g., an event map) generated by the mapper 124. In some cases, the event data can include an event map that correlates detected events of interest (and/or associated data such as keyframes, extracted image features, event counts, etc.) with one or more specific environments (and/or portions/regions of the specific environments) in which such detected events occurred (and/or were detected). In some examples, the keyframes in the event data can include keyframes created based on frames associated with detected events of interest. The mapper 124 can determine whether to create a new keyframe (or replace an existing keyframe) associated with an event, and record (or update) an event count associated with that keyframe in the event data. The event data can include a number of keyframes corresponding to one or more locations/environments where events of interest have been observed (e.g., detected from one or more frames obtained by the camera device) and event counts associated with those keyframes. The controller 126 can use the event data to modulate one or more settings (e.g., framerate, resolution, power mode, number of image sensors invoked, binning mode, imaging mode, etc.) of the camera device (e.g., one or more settings of the image sensor 102 and/or one or more other hardware and/or software components) based on a match between an incoming frame from the camera device and a keyframe in the event data.

In some cases, the event data can include an event map, classification data, keyframe data, features extracted from frames, classification map data, event statistics, and/or a dictionary with entries containing visual features of keyframes and the number of occurrences of detected events of interest that coincide with each of the keyframes (and/or the number of matches to the keyframe). For example, the event data can include a dictionary with an entry indicating n number of face detection events are associated with one or more visual features corresponding to keyframe x. In some examples, the mapper 124 can compute a count (e.g., for recorded keyframes) for each event. In some cases, the count can include a count and/or an average of occurrences of the event of interest within a certain period of time. In some cases, the count can include a total count of occurrences of the event of interest. In some examples, the mapper 124 can determine a total count based on a sum of the count of events of interest across keyframes that are associated with an environment(s) corresponding to the events and/or a region/portion of the environment(s). The count for an event can be used to determine a prior probability of that event for a given keyframe associated with that event. For example, the count of detection events for keyframes x and y (or the number of matches to keyframes x and y) can be used to determine that a first measure of detection events are associated with keyframe x and a second measure of detection events are associated with keyframe y.

The controller 126 can use the probabilities to adjust one or more settings of the camera device (e.g., the camera device associated with image sensor 102) when the camera device is in an environment associated with a keyframe in the event data (e.g., based on a match between a frame captured in that environment and a keyframe in the event data and associated with that environment). In some cases, the controller 126 can alternatively or additionally use the probabilities to adjust one or more settings of other components of the electronic device 100, such as another camera device (e.g., a camera device associated with image sensor 104, a camera device employing and/or having capabilities to employ higher-power camera settings than the camera device associated with image sensor 102, etc.), a processing component and/or pipeline, etc., when the electronic device 100 is or is not in an environment associated with a keyframe in the event data.

The mapper 124 can determine whether to create a new entry in the event data based on one or more factors. For example, in some cases, the mapper 124 can determine whether to create a new entry in the event data depending on whether a current frame captured by the camera device (e.g., the camera device associated with image sensor 102) matches an existing keyframe in the event data, whether a camera event of interest was detected in the current frame, a time elapsed since a last keyframe was created, a time elapsed since a last keyframe match, etc. In some cases, the mapper 124 can employ a periodic culling process to eliminate map entries with lower likelihoods of events (e.g., with likelihoods having a probability value at or below a threshold).

In some examples, the controller 126 can modulate one or more settings of the camera device (e.g., the camera device associated with image sensor 102) such as, for example and without limitation, increasing or decreasing a framerate, a resolution, a power mode, an imaging mode, a number of image sensors invoked to capture one or more images associated with an event of interest, processing actions and/or a processing pipeline for processing captured images and/or detecting events in captured images, etc. For example, in some cases, the electronic device 100 may be statistically more likely to encounter certain events of interest in certain environments. In some cases, to avoid wasting unnecessary power when the electronic device 100 is located in an environment where the electronic device 100 has a lower likelihood of encountering an event of interest, the controller 126 can turn off the camera device or modulate one or more settings of the camera device to reduce power usage by the camera device when the electronic device 100 is in the environment associated with the lower likelihood of encountering an event of interest. When the electronic device 100 is located in an environment where the electronic device 100 has a higher likelihood of encountering an event of interest, the controller 126 can turn on the camera device or modulate one or more settings of the camera device to increase power usage by, and/or performance of, the camera device when the electronic device 100 is in the environment associated with the higher likelihood of encountering an event of interest.

In some cases, the controller 126 can modulate one or more settings of a camera device(s) (e.g., image sensor 102, image sensor 104) based on the camera event prior probabilities for a currently (or recently within a threshold period) matched keyframe. In some examples, the controller 126 can incorporate a configurable framerate for each camera event of interest. In some examples, when the mapper 124 indicates a matched keyframe, the controller 126 can set the framerate of the camera device to a framerate equal to the configurable framerate times the prior probability for the matched keyframe entry in the event data. In some examples, the camera device can maintain this framerate for a configurable period of time or until the next matched keyframe. In some cases, when/if there are no current (or recently within a threshold period) matched keyframes, the camera device can implement a default framerate, such as a lower framerate that results in lower power consumption during periods of unlikely detection events.

In some examples, the electronic device 100 (and/or the controller 126 on the electronic device 100) can monitor (and implement the techniques described herein for) various types of events. Non-limiting examples of detection events can include face detection, scene detection (e.g., sunset, room, etc.), human group detection, animal/pet detection, code (e.g., QR code, etc.) detection, document detection, infrared LED detection (e.g., as with a six degrees of freedom (6 DOF) motion tracker), plane detection, text detection, device detection (e.g., controller, screen, gadget, etc.), gesture detection (e.g., smile detection, emotion detection, hand waving, etc.), among others.

In some cases, the mapper 124 can employ a periodic decay normalization process by which event counts are decreased by a configurable amount across map entries. This can keep the count values numerically bound and allow for more rapid adjustment of priors when event/keyframe correlations change.

In some cases, the camera device (e.g., image sensor 102) can implement a decaying default setting, such as a framerate. For example, a reduced framerate can be associated with an increased event detection latency (e.g., a higher framerate can result in a lower latency). For a default framerate (e.g., a framerate when no keyframes have been matched), the controller 126 may default the framerate of the camera device to a lower framerate (e.g., which can result in a higher detection latency) when the event data contains a smaller number (e.g., below a threshold) of recorded events. For such cases, the controller 126 can implement a default framerate that begins at a threshold level but decays as more events are added to the event data (e.g., as the electronic device learns which locations/environments are most associated with events of interest).

In some cases, the mapper 124 can use non-camera events for the mapper decision-making. For example, the mapper 124 can use non-camera events such as a creation of new keyframes, culling/elimination of stale keyframes, etc. In some cases, the controller 126 can modulate non-camera workloads/resources based on keyframes and/or non-camera events. For example, the controller 126 can implement one or more audio algorithms (e.g., beamforming, etc.) modulated by camera device keyframes and/or audio-based presence detection. As another example, the controller 126 can implement location services (e.g., Global Navigation Satellite System (GNSS), Wi-Fi, etc.), application data, user inputs, and/or other data, modulated by camera device keyframes and/or use of location services.

In some cases, the IMU 108 can detect an acceleration, angular rate, and/or orientation of the electronic device 100 and generate measurements based on the detected acceleration. In some cases, the IMU 108 can detect and measure the orientation, linear velocity, and/or angular rate of the electronic device 100. For example, the IMU 108 can measure a movement and/or a pitch, roll, and yaw of the electronic device 100. In some examples, the electronic device 100 can use measurements obtained by the IMU 108 and/or data from one or more of the image sensor 102, the image sensor 104, the audio sensor 106, etc., to calculate a pose of the electronic device 100 within 3D space. In some cases, the electronic device 100 can additionally or alternatively use sensor data from the image sensor 102, the image sensor 104, the audio sensor 106, and/or any other sensor to perform tracking, pose estimation, mapping, generating event data entries, and/or other operations as described herein.

The components shown in FIG. 1 with respect to the electronic device 100 are illustrative examples provided for explanation purposes. In other examples, the electronic device 100 can include more or less components than those shown in FIG. 1. While the electronic device 100 is shown to include certain components, one of ordinary skill will appreciate that the electronic device 100 can include more or fewer components than those shown in FIG. 1. For example, the electronic device 100 can include, in some instances, one or more memory devices (e.g., RAM, ROM, cache, and/or the like), one or more networking interfaces (e.g., wired and/or wireless communications interfaces and the like), one or more display devices, caches, storage devices, and/or other hardware or processing devices that are not shown in FIG. 1. An illustrative example of a computing device and/or hardware components that can be implemented with the electronic device 100 are described below with respect to FIG. 7.

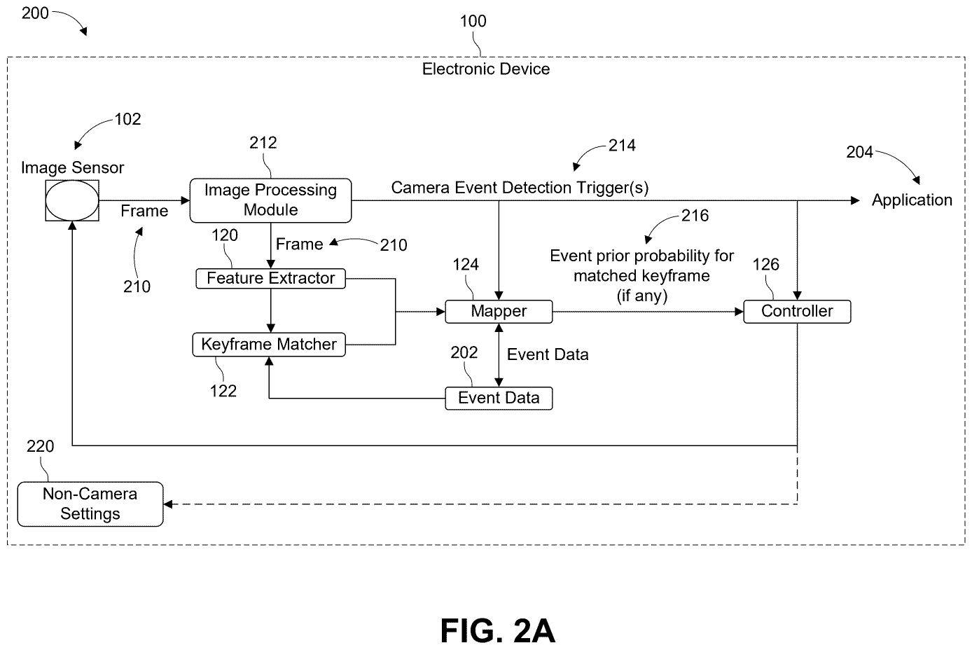

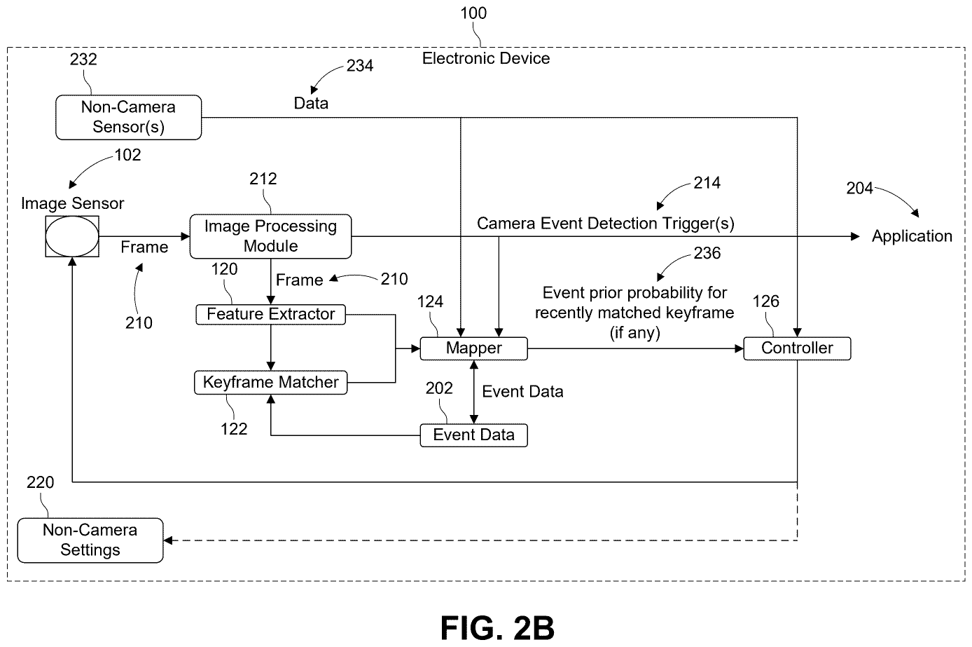

FIG. 2A is a diagram illustrating an example system process 200 for mapping events associated with an environment and controlling settings (e.g., power states, operations, parameters, etc.) of a camera device based on mapped events. In this example, the image sensor 102 can capture a frame 210 of a scene and/or an event in an environment where the image sensor 102 is located. In some examples, the image sensor 102 can monitor an environment and/or look for events of interest in the environment to capture a frame of any event of interest in the environment. An event of interest can include, for example and without limitation, a gesture (e.g., a hand gesture, etc.), an emotion (e.g., a smile, etc.), an activity or action (e.g., by a person, a device, an animal, etc.), an occurrence or present of an object, etc. An object associated with an event of interest can include, represent, and/or refer to, for example and without limitation, a face, a scene (e.g., a sunset, a park, a room, etc.), a person, a group of people, an animal, a document, a code (e.g., a QR code, a barcode, etc.) on an object (e.g., a device, a document, a display, a structure such as a door or wall, a sign, etc.), a light, a pattern, a link on an object, a plane in a physical space (e.g., a plane on a surface, etc.), text, infrared (IR) light-emitting diode (LED) detection, and/or any other object.

The electronic device 100 can use an image processing module 212 to perform one or more image processing operations on the frame 210. In some examples, the one or more image processing operations can include object detection to detect one or more camera event detection triggers 214 based on the frame 210. For example, the image processing module 212 can extract features from the frame and use the extracted features for object detection. The image processing module 212 can detect the one or more camera event detection triggers 214 based on the extracted features. The one or more camera event detection triggers 214 can include one or more events of interest as previously described. In some examples, the one or more image processing operations can include a camera processing pipeline associated with the image sensor 102. In some cases, the one or more image processing operations can detect and/or recognize one or more camera event detection triggers 214. The image processing module 212 can provide the one or more camera event detection triggers 214 to the feature extractor 120, the mapper 124, the controller 126, and/or an application 204 on the electronic device 100. The feature extractor 120, the mapper 124, the controller 126, and/or the application 204 can use the one or more camera event detection triggers 214 to perform one or more actions as described herein, such as application operations, camera setting adjustments, object detection, object recognition, etc. For example, the one or more camera event detection triggers 214 can be configured to trigger one or more actions by the feature extractor 120, the mapper 124, the controller 126, and/or the application 204, as explained herein.

In some examples, the application 204 can include any application on the electronic device 100 that can use information about events detected in an environment. For example, the application 204 can include an authentication application (e.g., facial authentication application, etc.), an XR application, a navigation application, an application for ordering or purchasing items, a video game application, a photography application, a device management application, a web application, a communications application (e.g., a messaging application, a video and/or voice application, etc.), a media playback application, a social media network application, a browser application, a scanning application, etc. The application 204 can use the one or more camera event detection triggers 214 to perform one or more actions. For example, if the application 204 is an XR application, the application 204 can use the one or more camera event detection triggers 214 to discover an event in the environment for use by the application 204, such as for example, a device (e.g., a controller or other input device, etc.), a hand, a boundary, a person, etc. As another example, the application 204 can use the one or more camera event detection triggers 214 to scan a document, link, or code and perform an action based on the document, link, or code. As yet another example, if the application 204 is a smart home assistant application, the application 204 can use the one or more camera event detection triggers 214 to discover a presence of a person and/or object to trigger a smart home device operation/action.

Moreover, the feature extractor 120 can analyze the frame 210 to extract visual features in the frame 210. In some examples, the feature extractor 120 can perform object recognition to extract visual features in the frame 210 and classify an event associated with the extracted features. In some cases, the feature extractor 120 can implement an algorithm to extract visual features from the frame 210 and determine a descriptor(s) of the extracted features. Non-limiting examples of a feature extractor/detector algorithm can include SIFT, SURF, ORB, and the like.

The feature extractor 120 can provide features extracted from the frame 210 and an associated descriptor(s) to the keyframe matcher 122 and the mapper 124. The associated descriptor(s) can identify and/or describe the features extracted from the frame 210 and/or an event detected from the extracted features. In some examples, the associated descriptor(s) can include a tag, label, identifier, and/or any other descriptor.

The keyframe matcher 122 can use the features and/or descriptor(s) from the feature extractor 120 to determine whether the electronic device 100 is located (or determine a likelihood that the electronic device 100 is located) in an environment (or a region/location within an environment) where events of interest have been previously detected. In some examples, the keyframe matcher 122 can use event data 202 containing keyframes to determine whether the electronic device 100 is located (or determine a likelihood that the electronic device 100 is located) in an environment (or a region/location within an environment) where events of interest have been previously detected. In some examples, the event data 202 can include keyframes corresponding to frames capturing detected events of interest. In some cases, the event data 202 can include a number of keyframes corresponding to locations/environments where events of interest have been observed (e.g., detected from one or more frames obtained by the image sensor 102 or the image sensor 104) and event counts associated with those keyframes.

In some cases, the event data 202 can include an event map, event entries, classification data, one or more keyframes, a classification map, event statistics, extracted features, feature descriptors, and/or any other data. In some examples, the event data 202 can include a dictionary with entries containing visual features of keyframes and the number of occurrences of detected events of interest (e.g., event counts) that coincide with each of the keyframes (and/or the number of matches to the keyframe). For example, the event data 202 can include a dictionary with an entry indicating n number of QR code detection events (e.g., n number of previous detections of a QR code) are associated with one or more visual features corresponding to keyframe x. In some cases, the keyframe matcher 122 can employ a periodic decay normalization process by which event counts are decreased by a configurable amount across one or more event data entries. For example, the keyframe matcher 122 can employ a periodic decay normalization process by which event counts are decreased by a configurable amount across all event data entries. This can keep the count values numerically bound and allow for more rapid adjustment of priors when event/keyframe correlations change.

In some examples, the keyframe matcher 122 can compare the features extracted from the frame 210 with features of keyframes in the event data 202. In some examples, the keyframe matcher 122 can compare a descriptor(s) of the features extracted from the frame 210 with descriptors of features of keyframes in the event data 202. Since the keyframes in the event data 202 correspond to an environment or a location in an environment where an event of interest has previously been detected, a match between the features extracted from the frame 210 (and/or an associated descriptor) and features of a keyframe in the event data 202 (and/or an associated descriptor) can indicate that the electronic device 100 is located (or a likelihood that the electronic device 100 is located) in an environment or a location in the environment where an event of interest has previously been detected. In some examples, the keyframe matcher 122 can correlate the frame 210 and/or the features extracted from the frame 210 to a particular environment (and/or a location/region within the particular environment) based on a match between the features extracted from the frame 210 and the features keyframes in the event data 202. Such correlation can indicate that the electronic device 100 is located in the particular environment (and/or the location/region within the particular environment). Information about that the electronic device 100 being located in an environment or a location in the environment where an event of interest has previously been detected can be used to determine a likelihood that an event of interest will be detected again when the electronic device 100 is located in the environment or the location in the environment.

For example, in some cases, the likelihood that an event of interest will be observed/detected in an environment may increase or decrease depending on whether the event of interest has previously been observed/detected in that environment and/or the number of times that the event of interest has previously been observed/detected in that environment. To illustrate, a determination that an event of interest has been observed/detected frequently in a particular room can suggest a higher likelihood that the event of interest will be observed/detected again when electronic device 100 is in the particular room than a determination that no events of interest have previously been observed/detected in the particular room. Thus, a determination that the electronic device 100 is located in an environment or a location in the environment where an event of interest has previously been detected can be used to determine a likelihood that an event of interest will be detected again when the electronic device 100 is located in the environment or the location in the environment. As previously explained, in some examples, the determination that the electronic device 100 is located in an environment or location where an event of interest has previously been detected can be based on a match between features extracted from the frame 210 and features of one or more keyframes in the event data that are correlated with the particular environment or location.

As further described herein, the likelihood that the event of interest will be detected again when the electronic device 100 is located in the environment or the location in the environment can be used to control device and/or processing settings (e.g., power modes, operations, device configurations, processing configurations, processing pipelines, etc.) to reduce power consumption and increase power savings when the electronic device 100 is located in an environment (or location thereof) associated with a lower likelihood of an event detection. Similarly, the likelihood that the event of interest will be detected again when the electronic device 100 is located in the environment or the location in the environment can be used to control device and/or processing settings to increase a performance and/or operating state of the electronic device 100 when the electronic device 100 is located in an environment (or location thereof) associated with a higher likelihood of an event detection, such as increasing an event detection performance, an imaging and/or image processing performance (e.g., image/imaging quality, resolution, scaling, framerate, etc.), etc.

The keyframe matcher 122 can provide the mapper 124 a result of the comparison of the features extracted from the frame 210 and the features of keyframes in the event data 202. For example, the keyframe matcher 122 can provide the mapper 124 an indication that the features extracted from the frame 210 match features of a keyframe in the event data 202 or do not match features of any keyframes in the event data 202. The mapper 124 can use the information from the keyframe matcher 122 to determine whether to create a new keyframe (or replace an existing keyframe) associated with an event, and record (or update) an event count associated with that keyframe. For example, if the features extracted from the frame 210 match features of a keyframe in the event data 202, the mapper 124 can increase a count of detected events associated with that keyframe in the event data 202. In some examples, the mapper 124 can record or update an entry with a count of detected events associated with that keyframe.

In some cases, if the features extracted from the frame 210 do not match features of any keyframes in the event data 202, the mapper 124 can create a new keyframe in the event data 202, which (e.g., the new keyframe) can correspond to the frame 210. For example, as previously described, the electronic device 100 previously detected (e.g., via the image processing module 212) the one or more camera event detection triggers 214 based on the frame 210, which can indicate that an event of interest has been detected in the frame 210. Accordingly, if the features extracted from the frame 210 do not match features of any keyframes in the event data 202, the mapper 124 can add a new keyframe in the event data 202 corresponding to the frame 210. The new keyframe can associate the features from the frame 210 with a detected event of interest and/or an associated environment (and/or location thereof). The mapper 124 can include in the event data 202 an event detection count associated with the new keyframe, and can increment the count anytime a new frame (or features thereof) match the features associated with the new keyframe.

The mapper 124 can use the count of detected events associated with the keyframe (e.g., the new keyframe or an existing keyframe) corresponding to the frame 210 and features associated with the frame 210, to determine or update an event prior probability 216 associated with that keyframe. For example, in some cases, the mapper 124 can use a total and/or average count of events associated with the keyframe corresponding to the frame 210, and associated environment, and/or features associated with the frame 210, to determine or update an event prior probability 216 associated with that keyframe. The event prior probability 216 can include a value representing an estimated likelihood/probability of detecting an event of interest in an environment or location in an environment associated with the frame 210 and/or the features of the frame 210. For example, if the frame 210 was captured from a particular room and the visual features in the frame 210 correspond to the particular room or an area/object in the particular room, the event prior probability 216 can indicate an estimated likelihood of detecting an event of interest when the electronic device 100 is in the particular room (and/or in the area of the particular room) and/or when visual features in a frame captured in the particular room (or an area of the particular room) match visual features in a keyframe in the event data 202 that is associated with that particular room and/or the area/object in the particular room.

In some examples, the event prior probability 216 can be at least partly based on the count of detected events of interest recorded for a keyframe associated with the event prior probability 216. In some cases, the likelihood/probability value in the event prior probability 216 associated with a keyframe can increase as the count of detected events of interest associated with that keyframe increases. In some cases, the likelihood/probability value in the event prior probability 216 can be further based on one or more other factors such as, for example, an amount of time between the detected events of interest associated with the keyframe, an amount of time since the last detected event of interest associated with the keyframe and/or the last n number of detected events of interest associated with the keyframe, a type and/or characteristic of a detected event(s) of interest associated with the keyframe, a number of frames captured in an environment associated with the keyframe that have yielded a positive detection result relative to a number of frames captured in that environment that have yielded a negative detection result, one or more characteristics of the environment (e.g., a size of the environment, a number or density of potential events of interest in the environment, a common activity performed in the environment, etc.) associated with the keyframe, a frequency of use (and/or an amount of time of use) of the electronic device 100 in the environment associated with the keyframe (e.g., higher usage with lower positive detection results can be used to reduce a likelihood/probability value and vice versa), and/or any other factors.

For example, an increase or decrease in time between detected events of interest in an environment associated with the keyframe can be used to increase or decrease a likelihood/probability value in the event prior probability 216. As another example, an increase or decrease in the number of frames captured in the environment that have yielded a positive detection relative to the number of frames captured in that environment that have yielded a negative detection result can be used to increase or decrease the likelihood/probability value in the event prior probability 216. As yet another example, a number of detected events of interest in an environment relative to an amount of use of the electronic device 100 in that environment can be used to decrease or increase the likelihood/probability value in the event prior probability 216 (e.g., more use with less detected events of interest can result in a lower likelihood/probability value than less use with more detected events of interest or the same amount of detected events of interest).

The mapper 124 can provide the event prior probability 216 associated with the matched keyframe to the controller 126. The controller 126 can use the event prior probability 216 to control/adjust one or more settings associated with the image sensor 102 and/or the image processing associated with the image sensor 102. For example, the controller 126 can use the event prior probability 216 to adjust one or more settings to decrease a power consumption of the electronic device 100 when the event prior probability 216 indicates a lower likelihood/probability of an event of interest in a current environment of the electronic device 100, or adjust one or more settings to increase a performance and/or processing capabilities of the electronic device 100 (e.g., a performance of the image sensor 102) when the event prior probability 216 indicates a higher likelihood/probability of an event of interest in the current environment of the electronic device 100.

To illustrate, when the event prior probability 216 indicates a higher likelihood/probability of an event of interest in the current environment of the electronic device 100, the controller 126 can increase a framerate, resolution, scale factor, image stabilization, power mode, and/or other settings associated with the image sensor 102; invoke additional image sensors; implement an image processing pipeline and/or operations associated with higher performance, complexity, functionalities, and/or processing capabilities; invoke or initialize a higher-power or main camera device (e.g., image sensor 104); turn on an active depth transmitter system such as a structured light system or flood illuminator, dual camera system for depth and stereo or a time-of-flight camera component; etc.

On the other hand, when the event prior probability 216 indicates a lower likelihood/probability of an event of interest in the current environment of the electronic device 100, the controller 126 can turn off the image sensor 102; decrease a framerate, resolution, scale factor, image stabilization, and/or other settings associated with the image sensor 102; invoke a lower number of image sensors; implement an image processing pipeline and/or operations associated with lower power consumption, performance, complexity, functionalities, and/or processing capabilities; turn off an active depth transmitter system such as a structured light system or flood illuminator, dual camera system, a time-of-flight camera component; etc. This way, the controller 126 can increase power savings, performance, and/or capabilities of the electronic device 100 and associated components based on the likelihood/probability of a presence/occurrence of an event of interest in the current environment of the electronic device 100.

In some cases, the controller 126 can also modulate non-camera settings 220 based on the event prior probability 216 (e.g., based on the likelihood/probability of a presence/occurrence of an event of interest in the current environment of the electronic device 100). For example, the controller 126 can (e.g., based on the likelihood/probability of a presence/occurrence of an event of interest in the current environment of the electronic device 100) turn on/off, increase/decrease a power mode, and/or increase/decrease a processing capability and/or complexity of one or more components, algorithms, services, etc., such as an audio algorithm(s) (e.g., beamforming, etc.), location services (e.g., GNSS or GPS, WIFI, etc.), a tracking algorithm, an audio device (e.g., audio sensor 106), a non-camera workload, an additional processor, etc.

In some cases, the electronic device 100 can also leverage non-camera events to map events associated with an environment and control device settings (e.g., power states, operations, parameters, etc.) based on mapped events. For example, with reference to FIG. 2B, the electronic device 100 can use data 234 from non-camera sensors 232 to update the event data 202 (e.g., add new keyframes and associated detection counts, update existing keyframes and/or detection counts, remove existing keyframes and/or detection counts) and/or compute the event prior probability 236 for a matched keyframe.

The non-camera sensors 232 can include, for example and without limitation, an audio sensor (e.g., audio sensor 106), an IMU (e.g., IMU 108), a radar, a GNSS or GPS sensor/receiver, a wireless receiver (e.g., WIFI, cellular, etc.), etc. The data 234 from the non-camera sensor 232 can include, for example and without limitation, information about a location/position of the electronic device 100, a distance between the electronic device 100 and one or more objects, a location of one or more objects within an environment, a movement of the electronic device 100, sound captured in an environment, a time of one or more events, etc.

In some examples, the data 234 from the non-camera sensors 232 can be used to supplement data associated with updates (e.g., keyframes and/or associated data) to the event data 202. For example, the data 234 from the non-camera sensors 232 can be used to add timestamps of events associated with a keyframe added, updated or removed in the event data 202; indicate a location/position of the detected event associated with the keyframe; indicate a location/position of the electronic device 100 before, during, and/or after a detected event; an indication of movement of the electronic device 100 during the detected event, indicate a proximity of the electronic device 100 to the detected event, an indication of audio features associated with the detected event and/or environment, an indication of one or more characteristics of the environment (e.g., location, geometry, configuration, activity, objects, etc.), etc. The mapper 124 can use the data 234 in conjunction with features/descriptors and/or counts associated with keyframes in the event data 202 to help determine the likelihood/probability value in the event prior probability 236 of a matched keyframe; provide more granular information (e.g., location, activity, movement, time, etc.) about the environment, the electronic device 100, and/or the detected event associated with a matched keyframe; cull/eliminate stale keyframes; determine whether to add, update, or remove a keyframe (and/or associated information) to/in/from the event data 202; verify detected events; etc.

In some cases, the controller 126 can also use the data 234 from the non-camera sensors 232 to determine how or what settings to adjust/modulate as previously described. For example, the controller 126 can use the data 234 in conjunction with the event prior probability 236 to determine what setting of the image sensor 102 to adjust (and/or how), what settings from one or more other devices on the electronic device 100 to adjust (and/or how), which of the non-camera settings 220 to adjust (and/or how), etc. For example, as previously explained, in some cases, when the event prior probability indicates a higher likelihood of an event of interest occurring in a current environment of the electronic device 100, the controller 126 can increase a framerate of the image sensor 102 and/or activate a higher-power or main camera device with higher framerate capabilities (e.g., as compared to a camera device associated with image sensor 102). In this example, if the data 234 indicates a threshold amount of motion associated with the detected event of a matched keyframe and/or the electronic device 100, the controller 126 can increase the framerate of the image sensor 102 and/or the higher-power or main camera device more than if the data 234 indicates the amount of motion is below the threshold.

As another example, if the data 234 indicates that the electronic device 100 is approaching a location in an environment within a proximity of a location of a prior event of interest, the controller 126 can activate a higher-power or main camera device (e.g., a camera device having higher-power capabilities/settings as compared to a camera device associated with image sensor 102) and/or increase a setting of the image sensor 102 prior to the electronic device 100 reaching the location of the prior event of interest. Similarly, if the data 234 indicates that the electronic device 100 is moving away from the environment, the controller 126 can modulate one or more settings (e.g., turn off the image sensor 102 or another device, reduce a power mode of the image sensor 102 or another device, reduce a processing complexity and/or power consumption, etc.) to reduce a power consumption by the electronic device 100 even if an event of interest is determined to have a higher likelihood/probability (e.g., based on the event prior probability) of occurring in the environment. As yet another example, if the event prior probability indicates a higher likelihood of an event of interest occurring in the environment of the electronic device 100 and the data 234 indicates a threshold amount of motion by the electronic device 100 and/or one or more objects in the environment, the controller 126 can activate, and/or increase a complexity/performance of, an image stabilization setting/operation to ensure better image stabilization of any frames capturing an event of interest in the environment.

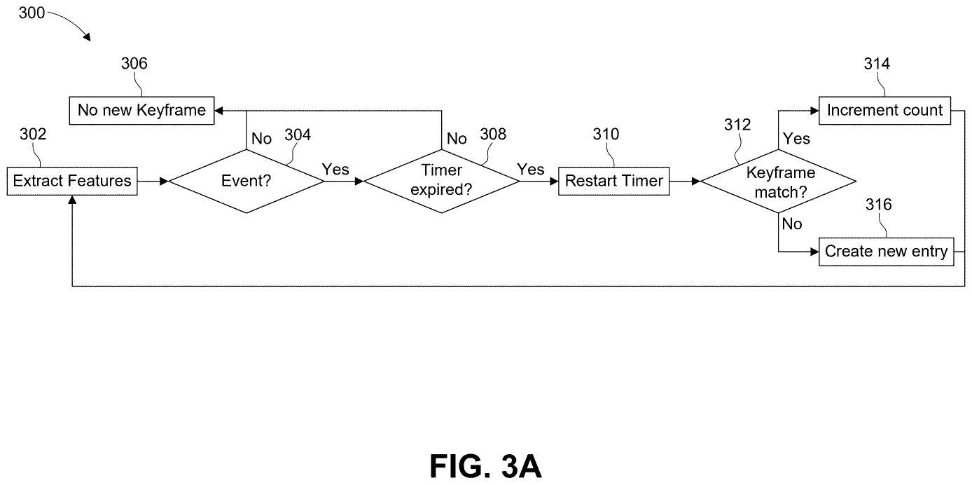

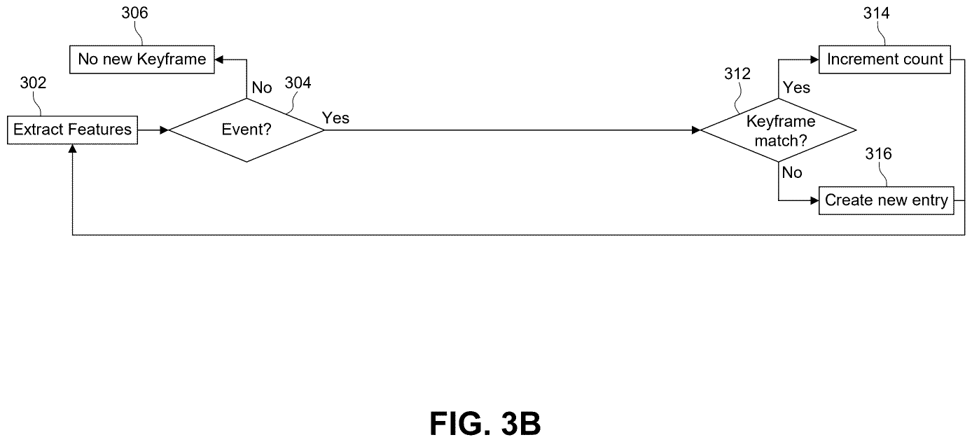

FIG. 3A is a diagram illustrating an example process 300 for updating event data (e.g., event data 202). In this example, at block 302, the electronic device 100 can extract features from a frame captured by a camera device of the electronic device 100 (e.g., a camera device associated with image sensor 102, a camera device associated with image sensor 104).

At block 304, the electronic device 100 can determine, based on the extracted features, if an event of interest is detected in the frame. At block 306, if an event of interest is not detected in the frame, the electronic device 100 does not add a new keyframe to the event data. If an event of interest is detected in the frame, at block 308, the electronic device 100 can optionally determine if a timer has expired since a keyframe was created (e.g., was added to the event data) by the electronic device 100 and/or at block 312, the electronic device 100 can determine if a match has been identified between a keyframe in the event data and visual features extracted from a frame.

The timer can be programmable. In some cases, the timer (e.g., the amount of time configured to trigger expiration of the timer) can be determined based on one or more factors such as, for example, a usage history and/or pattern associated with the electronic device 100, a pattern of detection events (e.g., a pattern associated with previous detections of one or more events of interest), types of events of interest configured to trigger a detection event (e.g., trigger a detection of an event of interest), one or more characteristics of one or more environments, etc. In some examples, the timer can be set to prevent a larger number of keyframes from being created and/or to prevent keyframes from being created too frequently.

For example, assume the electronic device 100 detects a QR code in a frame capturing the QR code from a restaurant menu on a refrigerator in a kitchen, and creates a keyframe associated with the QR code detected in the restaurant menu on the refrigerator. The detection of the QR code and the creation of the keyframe can indicate that the electronic device 100 is in a same room (e.g., the kitchen) as the QR code and is likely to be in that same room for at least a period of time. In this example, the timer can prevent the electronic device 100 from creating additional keyframes of events associated with that environment while the electronic device 100 is likely to remain in that environment. Accordingly, the timer can reduce the volume of keyframes created within a period of time, a power consumption from creating additional keyframes within the period of time, and a use of resources in creating the additional keyframes within the period of time.

If the timer has not expired, the process 300 can return to block 306, where the electronic device 100 determines not to add a new keyframe to the event data. If the timer has expired, at block 310, the electronic device 100 can restart or reset the timer. At block 312, the electronic device 100 can determine whether the features extracted from a frame at block 302 match features of a keyframe in the event data. For example, the electronic device 100 can compare the features extracted from the frame at block 302 and/or an associated descriptor with features in keyframes in the event data and/or associated descriptors.

At block 314, if the electronic device 100 finds a match between the features extracted from the frame at block 302 and features of a keyframe in the event data, the electronic device 100 can increment a count of detection events (e.g., a count of previous detections of one or more events of interest) associated with the matching keyframe in the event data. At block 316, if the electronic device 100 does not find a match between the features extracted from the frame at block 302 and features of any keyframes in the event data, the electronic device 100 can create a new entry in the event data for the detection event (e.g., a detection of an event of interest) associated with the features extracted from the frame at block 302. In some examples, the new entry can include a keyframe containing the features extracted from the frame at block 302 and an event count indicating the number of occurrences of the event of interest associated with the detection event. In some examples, the new entry can also include a descriptor of the features associated with the keyframe.

In some cases, the process 300 may not implement a timer and/or check if a timer has expired as described with respect to block 308 and block 310. For example, with reference to FIG. 3B, in some cases, after determining that an event of interest has been detected at block 304, the electronic device 100 can proceed to block 312 to determine if the features extracted from the frame at block 302 match features of a keyframe in the event data.

In other cases, the process 300 may implement a timer but checking if the timer has expired may be performed at a different point in the process. For example, in some cases, the electronic device 100 can check if the timer has expired prior (e.g., as described with respect to block 308) determining whether an event of interest has been detected (e.g., as described with respect to block 304). In some examples, if the timer has expired, the electronic device 100 can restart the timer (e.g., as described with respect to block 310) before determining whether an event of interest has been detected (e.g., as described with respect to block 304) or after determining that an event of interest has been detected.

In one or more aspects, an XR device (e.g., an AR device) can implement a low power camera (e.g., an always sensing camera, which may be referred to as an always-on camera) to augment the real (physical) world with virtual content, such as for room designing, virtual shopping, table top AR games, turn-by-turn navigation assistance, food and health monitoring, AR video calls, and/or virtual meetings. The device can accomplish this augmentation by mapping the physical world, localizing itself in that physical world, and positioning and/or rendering virtual content on a near-eye display (e.g., on the device) that is visible to the user (e.g., wearing the device). Many XR devices (e.g., AR devices) can utilize hand and/or fingertip tracking to allow for users to control interfaces in the augmented reality.

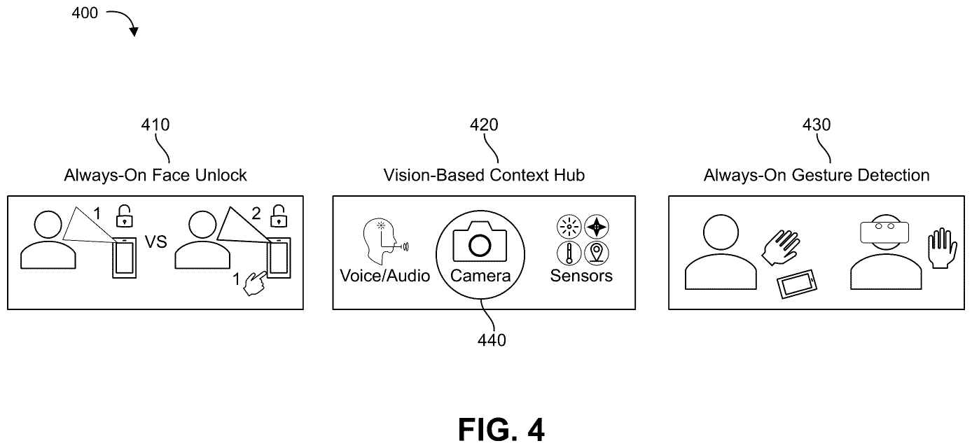

In one or more examples, mobile devices (e.g., XR devices, which are head mounted, and/or handheld devices) have been increasingly leveraging specialized ultra-low power camera hardware for an always sensing camera (ASC). FIG. 4 shows examples of use cases for devices leveraging an ASC. In particular, FIG. 4 is a diagram illustrating examples 400 of use cases 410, 420, 430 for an always sensing camera (e.g., an always on camera) in a device (e.g., a mobile device). In FIG. 4, a first use case 410 is for an always-on face unlock. For this use case 410, the always sensing camera can unlock the mobile device for usage by the user when the always sensing camera detects a face of the user within a captured image (e.g., captured by the always sensing camera).

A second use case 420 is for a vision-based context hub. For this use case 420, a camera 440 (e.g., an always sensing camera) and sensors (e.g., including a temperature sensor), which are implemented within a device (e.g., a head-mounted device worn by a user), can obtain sensor data (e.g., including images and/or temperature data). The always sensing camera hardware can determine context (e.g., for a prompt) based on the sensor data.

A third use case 430 is for always-on gesture detection. For this use case 430, camera (e.g., an always sensing camera), implemented within a device (e.g., a mobile device associated with a user), can capture images. The always sensing camera hardware can detect gestures (e.g., of the user) based on the captured images.

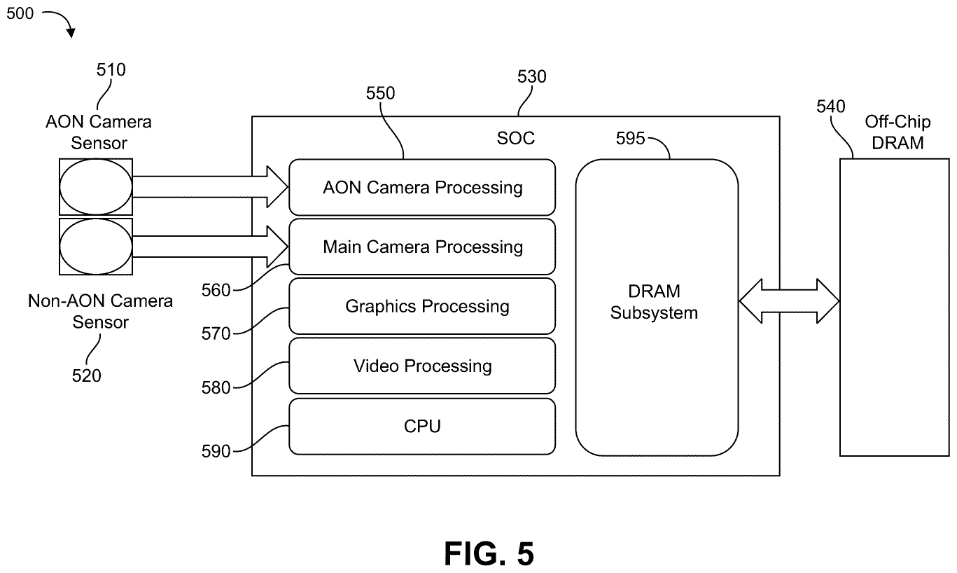

FIG. 5 shows an example system of a device with an always sensing camera. In particular, FIG. 5 is a diagram illustrating an example of a system 500 for a device with an always sensing camera (e.g., an always on camera, such as camera 440 of FIG. 4). In FIG. 5, the system 500 is shown to include an AON camera sensor 510 (e.g., an AON camera), a non-AON camera sensor 520 (e.g., a non-AON camera), a system on a chip (SOC) 530, and an off-chip dynamic random-access memory (DRAM) 540. The SOC 530 is shown to include an AON camera processing engine 550, a main camera processing engine 560, a graphic processing engine 570, a video processing engine 580, a CPU 590, and a DRAM subsystem 595.

In one or more examples, this specialized camera processing (e.g., by the AON camera processing engine 550, such as always sensing camera hardware) may be implemented as a parallel camera processing path (e.g., as shown in FIG. 5) with optimizations, such as using a low-resolution and low-power sensor (e.g., the AON camera sensor 510), using on-chip static random-access memory (SRAM) rather than DRAM (e.g., the DRAM subsystem 595), using island voltage rails to reduce leakage, and/or using ring oscillators for clock sources rather than phase lock loops (PLLs).

In one or more aspects, it can be important for XR devices (e.g., AR devices) to be able to track their own location in the physical world. In one or more examples, this tracking is inside-out 6 DOF tracking. This type of tracking is referred to as “inside-out” because the device can track itself without any external beacons or transmitters. The term 6 DOF refers to the device being able to track its own position in terms of three rotational vectors (e.g., pitch, yaw, and roll) as well as three translational vectors (e.g., up/down, left/right, and forward/back).

In one or more examples, visual inertial odometry may be employed to accomplish inside-out 6 DOF tracking of a device. Visual inertial odometry is performed by fusing together visual data (e.g., obtained by one or more image sensors) with inertial data (e.g., obtained by gyroscopes and accelerometers) to measure a distance the device moved within the physical world. Visual inertial odometry is often also used to simultaneously determine a position (e.g., localize) of the device in the physical world as well as a map of the physical world.

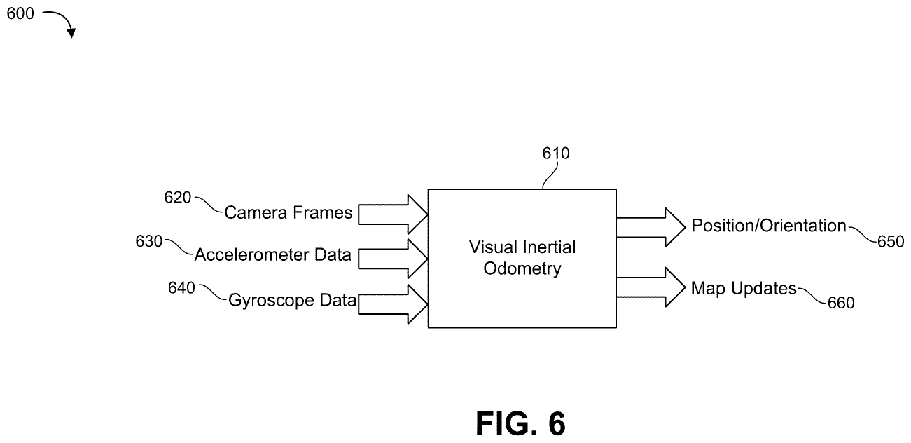

FIG. 6 shows an example process for visual inertial odometry. In particular, FIG. 6 is a diagram illustrating an example of a process 600 for inside-out 6 DOF tracking using visual inertial odometry 610. In FIG. 6, during operation of the process 600, one or more processors perform visual inertial odometry 610 by fusing together camera frames 620 with accelerometer data 630 and gyroscope data 640 to determine a distance the device moved within the physical world. The one or more processors, based on the visual inertial odometry 610, can determine a position and/or orientation 650 of the device and can update a map 660 of the real world.

In one or more examples, the visual data (e.g., camera frames 620) is important in this process 600. Determining the position of the device can be based entirely on double-integration of the acceleration (e.g., a process called dead reckoning), which is subject to cumulative error (e.g., referred to as drift) as time proceeds. With the visual data (e.g., camera frames 620), visual landmarks can be used to calibrate the odometry and to eliminate this cumulative error. For this reason, XR devices (e.g., AR devices) can generally be assumed to have one or more world-facing camera sensors, a 3D map of the environment, and an understanding of the device position in that environment.

As mentioned, artificial intelligence (AI) assistants, associated with the electronic device, can have access to rich, always-available visual context derived from these captured images (e.g., captured by a low power camera, such as an AON camera, within the device). The current paradigm for this usage of visual context is to provide a snapshot (an image) alongside the verbal query from a user associated with the electronic device. However, in some cases, some context can be missed by just using a snapshot. For example, an object may be fast moving and, as such, the object is not able to be captured within the snapshot. For another example, the user's head (wearing the electronic device with the camera) may have moved in an opposite direction of the object and, as such, the object is not captured within the snapshot before the completion of generating a prompt for answering the query of the user. Using captured video of the scene can mitigate the issue with missing context. However, obtaining and processing the video can incur a power cost.

A key performance indicator for an AI assistant interaction is a time to first token (TTFT) on the output of the AI assistant. The TTFT corresponds to how reactive the AI assistances are perceived by the users. FIG. 7 shows an example of a TTFT of an AI assistant. In particular, FIG. 7 is a diagram illustrating an example of a processing timeline 700 for artificial intelligence assistance that includes a TTFT 780. In FIG. 7, the horizontal axis of the processing timeline 700 denotes time. At the beginning of the processing timeline 700, a model is loaded 710. Images (e.g., captured by an image sensor of the device) are gathered 720 and a prompt is composed 730. During execution (e.g., by one or more processors) of a large language model (LLM) 770, the images (e.g., along with visual context associated with the images) and the prompt are encoded 740, a first token is decoded 750, and ongoing decoding 760 occurs. The TTFT 780 is shown to be the time required for the encoding 740 of the images and prompt and the time required for the decoding of the first token 750. In FIG. 7, the encoding 740 is shown to take a lot of time due to the need to encode both the images and prompt.

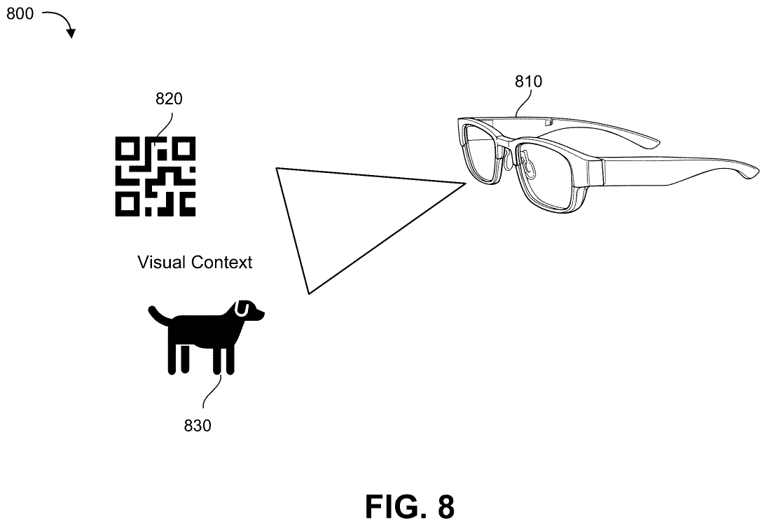

FIG. 8 shows an example device determining visual context from images. In particular, FIG. 8 is a diagram illustrating an example 800 of a device 810 (e.g., a wearable device, such as an XR device, for example an AR device) capable of capturing images and determining visual context from the images. In FIG. 8, the device 810 may include an always sensing camera (e.g., an AON image sensor). The device 810 (e.g., the AON camera sensor) is shown to capture images of a scene. One image includes a QR code 820, and another image includes a dog 830.

One or more processors (e.g., within always sensing camera hardware) of the device 810, based on the images, can detect objects within the images (e.g., the QR code 820 and the dog 830). The one or more processors (e.g., within the ways sensing camera hardware) of the device 810, based on the detected objects, can determine visual context for the scene. For example, the one or more processors can determine, based on the detection of the QR code 820, a restaurant as context for the scene (e.g., because the QR code 820 is associated with a menu for the restaurant). For another example, the one or more processors can determine, based on the detection of the dog 830, a dog park as context for the scene (e.g., because dogs are associated with dog parks).

As mentioned, a TTFT is a performance indicator for an AI assistant. As such, a TTFT that is short in duration is desirable. Obtaining a snapshot (e.g., an image) of a scene and encoding the snapshot (e.g., along with associated visual context), after composing a user prompt, can incur additional encoding time, which can increase the TTFT.

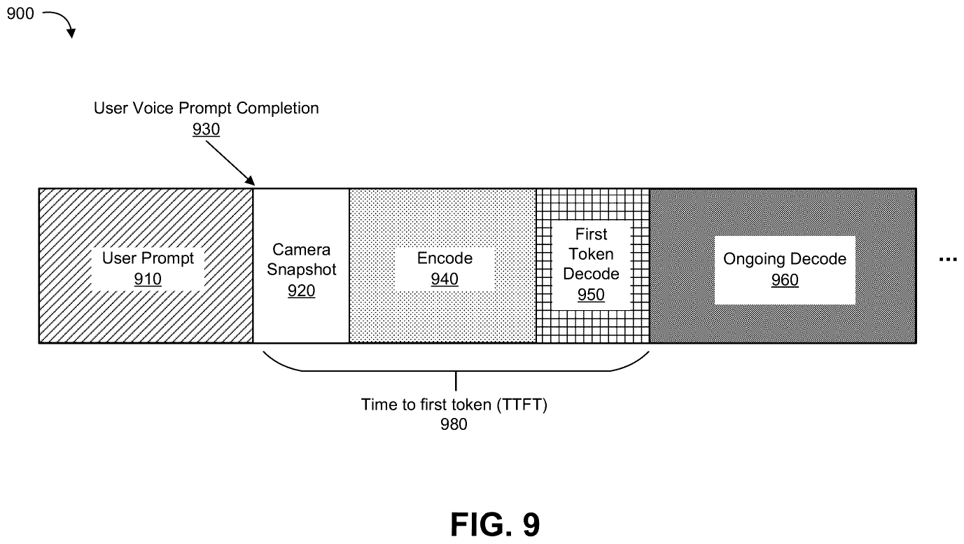

FIG. 9 shows an example of a TTFT including encoding of an image after the composition of a user prompt. In particular, FIG. 9 is a diagram illustrating an example of a processing timeline 900 for AI assistance showing an image 920 (e.g., camera snapshot) captured and encoded 940 after completion 930 of a user prompt 910. In FIG. 9, the horizontal axis of the processing timeline 900 denotes time. At the beginning of the processing timeline 900, a user prompt 910 is composed based on a query from a user for the AI assistant.

After completion 930 of the composition of the user prompt 910, an image 920 (e.g., camera snapshot) is captured by an image sensor. Visual context can be determined based on the image 920. The image 920 (e.g., along with the visual context) and the user prompt 910 are then encoded 940. A first token is decoded 950, and ongoing decoding 960 occurs. The TTFT 980 is shown to be the time required to capture the image 920 (e.g., camera snapshot), the time required for the encoding 940 of the image 920 and the user prompt 910, and the time required for the decoding of the first token 950. In FIG. 9, the encoding 940 (e.g., of the TTFT 980) is shown to take a lot of time due to the need to encode both the image 920 (e.g., camera snapshot) and the user prompt 910. Therefore, improved systems and techniques for low power camera sensing for AI assistance (e.g., with a shorter TTFT, which corresponds to a quicker reacting AI assistant) can be useful.

In one or more aspects, the systems and techniques provide solutions for low power camera sensing for AI assistance. In one or more examples, the systems and techniques provide solutions that leverage an low power camera (e.g., an AON camera) to monitor visual context for a prompt. In one or more examples, as known objects and/or scenes are recognized, these items are entered into a journal (e.g., log), which can be provided as prompt context for user-initiated AI assistance interactions (e.g., user queries for the AI assistant).

In one or more examples, the systems and techniques provide always sensing camera (ASC)-based visual context to AI assistants including a number of machine-learning triggers running in ASC, a journal in which ASC-based triggers are recorded, and a prompt composition process, which includes recent journal entries in user-initiated AI assistant queries. The systems and techniques further provide a method for reducing TTFT, in which speculative encoding of ASC-based images is done to avoid need for serialized snapshots and encoding.

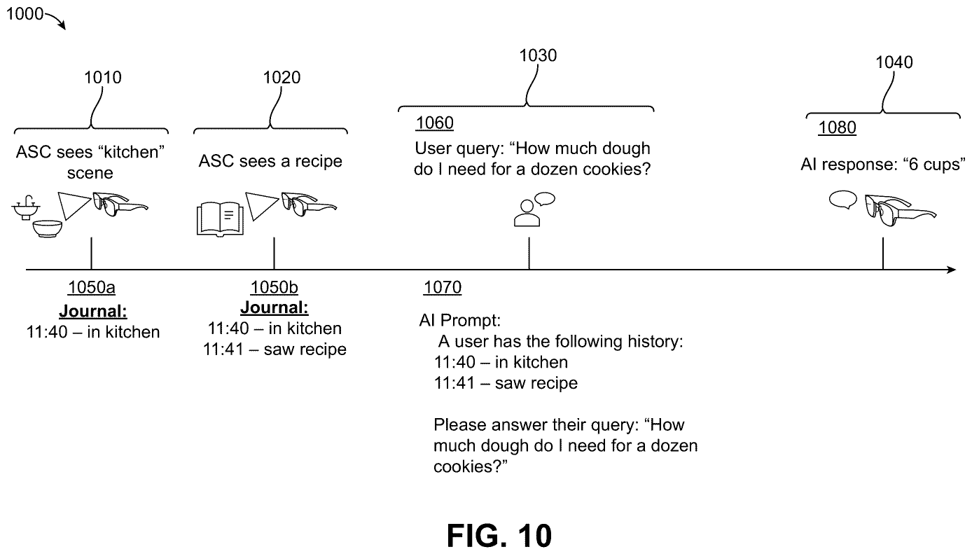

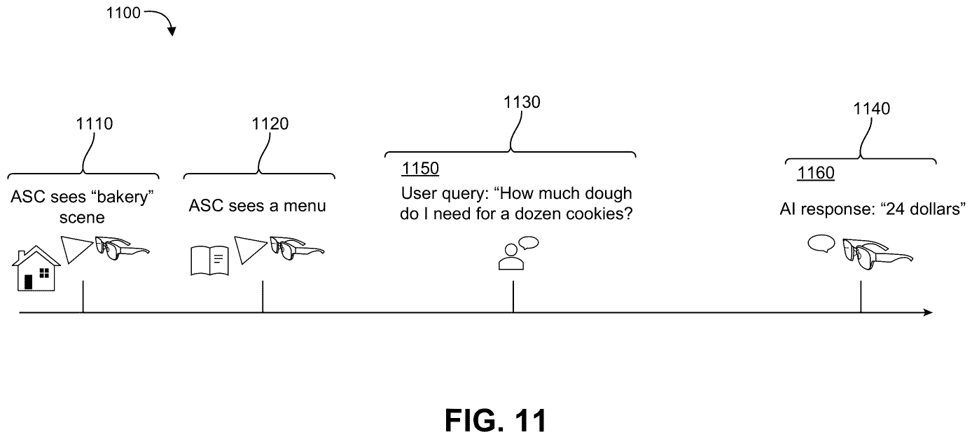

FIGS. 10 and 11 show example disclosed processes for AI assistance. In particular, FIG. 10 is a diagram illustrating an example of a process 1000 for AI assistance. In FIG. 10, the horizontal axis denotes time. During operation of the process 1000 of FIG. 10, at a first time duration 1010, an always sensing camera (e.g., AON image sensor) of a device (e.g., an XR device, such as an AR device) can obtain one or more images (e.g., including a kitchen sink and a salad bowl) of a scene. One or more processors (e.g., of always sensing camera hardware) of the device can detect, based on the images, objects (e.g., a kitchen sink and a salad bowl) within the one or more images. The one or more processors (e.g., of always sensing camera hardware), based on the detected images, can determine context of the scene. For example, the one or more processors can determine a kitchen as context for the scene based on the detected kitchen sink and salad bowl. The one or more processors can store the context (e.g., kitchen) along with a timestamp (e.g., corresponding to a specific time and day of when the one or more images were obtained) within a journal 1050a (e.g., a log).

At a second time duration 1020, the always sensing camera (e.g., AON image sensor) of the device (e.g., an XR device, such as an AR device) can obtain one or more images (e.g., including a cookbook with a recipe) of a scene. One or more processors (e.g., of always sensing camera hardware) of the device can detect, based on the images, objects (e.g., a cookbook with a recipe) within the one or more images. The one or more processors (e.g., of always sensing camera hardware), based on the detected images, can determine context of the scene. For example, the one or more processors can determine a recipe as context for the scene based on the detected cookbook with a recipe. The one or more processors can store the context (e.g., recipe) along with a timestamp (e.g., corresponding to a specific time and day of when the one or more images were obtained) within the journal 1050a (e.g., to produce an updated journal 1050b).

At a third time duration 1030, one or more processors of the device (e.g., an XR device, such as an AR device) can receive a query 1060 from the user of the device. In one or more examples, the query 1060 is “How much dough do I need for a dozen cookies?” The one or more processors, based on the context (e.g., kitchen and recipe) within the journal 1050b and the query 1060, can determine an AI prompt 1070.

At a fourth time duration 1040, the one or more processors, based on the prompt 1070, can determine a response 1080 to the query 1060. In one or more examples, the response 1080 is “6 cups.” The response 1080 is “6 cups” because the context including a kitchen and a recipe can lead to the interpretation of the term “dough” in the query 1060 as referring to a mixture of flour and water.

FIG. 11 is a diagram illustrating another example of a process 1100 for AI assistance. In FIG. 11, the horizontal axis denotes time. During operation of the process 1100 of FIG. 11, at a first time duration 1110, an always sensing camera (e.g., AON image sensor) of a device (e.g., an XR device, such as an AR device) can obtain one or more images (e.g., including a bakery) of a scene. One or more processors (e.g., of always sensing camera hardware) of the device can detect, based on the images, objects (e.g., a bakery) within the one or more images. The one or more processors (e.g., of always sensing camera hardware), based on the detected images, can determine context of the scene. For example, the one or more processors can determine a bakery as context for the scene based on the detected bakery. The one or more processors can store the context (e.g., bakery) along with a timestamp (e.g., corresponding to a specific time and day of when the one or more images were obtained) within a journal (e.g., a log).

At a second time duration 1120, the always sensing camera (e.g., AON image sensor) of the device (e.g., an XR device, such as an AR device) can obtain one or more images (e.g., including a menu) of a scene. One or more processors (e.g., of always sensing camera hardware) of the device can detect, based on the images, objects (e.g., a menu) within the one or more images. The one or more processors (e.g., of always sensing camera hardware), based on the detected images, can determine context of the scene. For example, the one or more processors can determine a menu as context for the scene based on the detected menu. The one or more processors can store the context (e.g., menu) along with a timestamp (e.g., corresponding to a specific time and day of when the one or more images were obtained) within the journal (e.g., to produce an updated journal).

At a third time duration 1130, one or more processors of the device (e.g., an XR device, such as an AR device) can receive a query 1150 from the user of the device. In one or more examples, the query 1150 is “How much dough do I need for a dozen cookies?” The one or more processors, based on the context (e.g., bakery and menu) within the journal and the query 1150, can determine an AI prompt.

At a fourth time duration 1140, the one or more processors, based on the prompt, can determine a response 1160 to the query 1150. In one or more examples, the response 1160 is “24 dollars.” The response 1160 is “24 dollars” because the context including a bakery and a menu can lead to the interpretation of the term “dough” in the query 1150 as referring to money or currency.

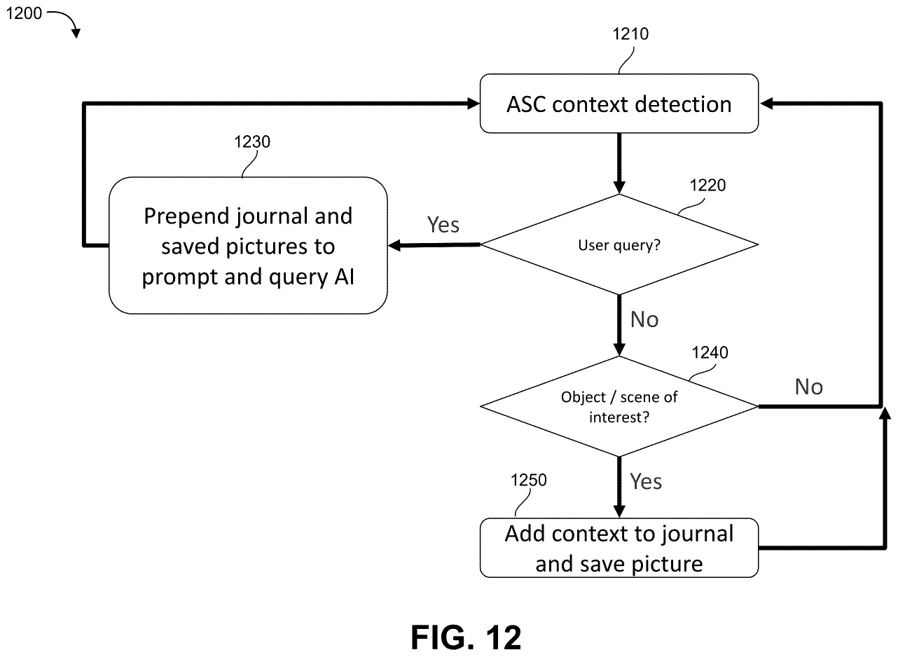

FIG. 12 is an example process for AI assistance. In particular, FIG. 12 is a flow diagram illustrating an example of process 1200 for AI assistance. During operation of the process 1200 of FIG. 12, at block 1210, one or more processors (e.g., of the always sensing camera hardware) of a device can perform ASC context detection. At decision block 1220, one or more processors of the device can determine whether the device has received a user query. If the one or more processors determine that the device has received a user query, at block 1230, the one or more processors can prepend a journal and saved pictures (e.g., images) to prompt and query the AI. The process 1200 can then proceed back to block 1210.

However, if the one or more processors determine that the device has not received a user query, at decision block 1240, the one or more processors can determine, based on the images, whether there is an object or scene of interest (e.g., an object or scene that can be determined or detected). If the one or more processors determine that there is not an object or scene of interest, the process 1200 can proceed back to block 1210.

However, if the one or more processors determine that there is an object or scene of interest, at block 1250, context can be added to the journal and the picture (e.g., image) can be saved. The process 1200 can then proceed back to block 1210.

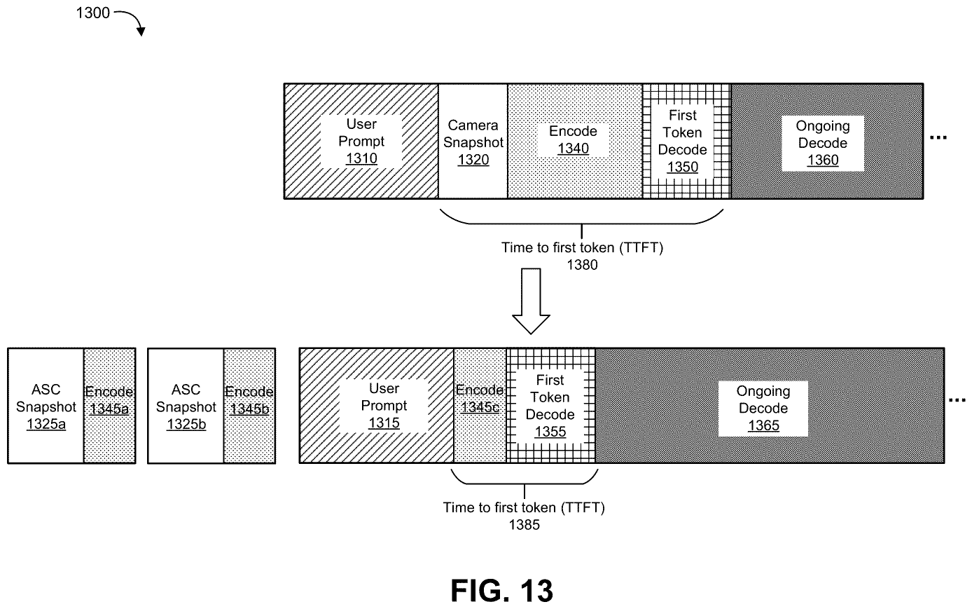

FIG. 13 shows a comparison of an existing processing timeline and a disclosed processing timeline for AI assistance. In one or more examples, the disclosed processing timeline for AI assistance can reduce the time duration for TTFT by speculatively encoding ASC-derived images, when interesting objects are detected within the images. In particular, FIG. 13 is a diagram illustrating a comparison of example 1300 processing timelines for AI assistance. In FIG. 13, two processing timelines for AI assistance are shown. In FIG. 13, the horizontal axis of each of the two processing timelines denotes time.

A top processing timeline for AI assistance shows an image 1320 (e.g., camera snapshot) captured and encoded 1340 after completion of a user prompt 1310. At the beginning of the top processing timeline, a user prompt 1310 is composed based on a query from a user for the AI assistant. After completion of the composition of the user prompt 1310, an image 1320 (e.g., camera snapshot) is captured by an image sensor. Visual context can be determined based on the image 1320. The image 1320 (e.g., along with the visual context) and the user prompt 1310 are then encoded 1340. A first token is decoded 1350, and ongoing decoding 1360 occurs. The TTFT 1380 is shown to be the time required to capture the image 1320 (e.g., camera snapshot), the time required for the encoding 1340 of the image 1320 and the user prompt 1310, and the time required for the decoding of the first token 1350. In FIG. 13, the encoding 1340 (e.g., of the TTFT 1380) is shown to take a lot of time due to the need to encode both the image 1320 (e.g., camera snapshot) and the user prompt 1310.

The bottom processing timeline for AI assistance shows an images 1325a, 1325b (e.g., ASC snapshots) captured and encoded 1345a, 1345b prior to completion of a user prompt 1315 (e.g., before receiving a query from a user). At the beginning of the bottom processing timeline, one or more images sensors (e.g., ASC sensors, such as AON image sensors) of a device (e.g., an XR device, such as an AR device, which may be a head-mounted device) associated with a user can obtain a plurality of images 1325a, 1325b of a scene. Each image 1325a, 1325b is obtained at a respective time. One or more processors (e.g., of the ASC hardware) of the device can determine, based on the plurality of images 1325a, 1325b, one or more contexts for the scene. In one or more examples, the one or more contexts can be stored within a journal (e.g., a log). The one or more processors can encode 1345a, 1345b, based on the one or more contexts, each image 1325a, 1325b of the plurality of images 1325a, 1325b to produce a respective image encoding for each of the images 1325a, 1325b.

The one or more processors can receive a query from the user. The one or more processors can then generate a prompt 1315 (e.g., a user prompt) based on the query and the one or more contexts. The one or more processors can encode 1345c the prompt to produce a prompt encoding. The one or more processors can generate, based on the respective image encodings 1345a, 1345b and the prompt encoding 1345c, a token (e.g., a first token). The one or more processors can determine, based on decoding the token 1355, an answer to the query. In one or more examples, determining the answer to the query can be further based on language within the query. In some examples, determining the answer to the query can be further based on applying the language within the query to a large language model (LLM). Ongoing decoding 1365 can occur.

The TTFT 1385 is shown to be the time required for the encoding 1345c of the user prompt 1315 and the time required for the decoding of the first token 1355. As such, the TTFT 1385 is shown to be shorter in duration than the TTFT 1380 because the TTFT 1385 does not require time to capture the images 1325a, 1325b (e.g., ASC snapshots) and the time required for the encoding 1345a, 1345b of the images 1325a, 1325b.

In one or more aspects, as mentioned, the one or more contexts may be stored within a journal (e.g., a log). Every context (e.g., triggered event) can be added to the journal as it happens (e.g., along with the appropriate timestamp). In some examples, the contexts (e.g., events) can be removed from the journal after a certain amount of time (e.g., thirty minutes). For example, the one or more processors can remove at least one of the contexts (e.g., events) from the journal (e.g., log) based on an expiration of time from obtaining at least one image associated with the at least one context. Removing the contexts from the journal after a certain amount of time can provide a simple, low power design with low latency (e.g., a short TTFT).

In some examples, context (e.g., triggered event descriptions) and images can be embedded and added into a vector database as they occur (e.g., in the style of a retrieval-augmented generation (RAG)). When a user prompts an AI assistant, the prompt embedding can be used to conduct a vector search for the closest event descriptions and/or images, which can then be added to the prompt. Using a vector database can allow for targeted context, which can likely enable a longer useful context window.

For example, the journal (e.g., log) can be a vector database. The one or more processors can, based on the prompt 1315, generate a prompt embedding. The one or more processors can perform, based on the prompt embedding, a vector search within the vector database to determine event information (e.g., event descriptions and/or images). In some examples, the one or more processors can add the event information to the prompt 1315.

In one or more aspects, some ASC hardware (e.g., on devices, such as XR devices) may be resource-constrained, such as available memory may be limited to SRAM (versus DRAM), available general-purpose compute may be limited to small cores (e.g., M55) versus big cores (e.g., A78), available neural network compute may be limited to small cores (e.g., embedded NPU) versus big cores (NPU), and/or available voltage/frequency levels may be limited due to low-power power management/distribution. These listed constraints may translate into a limitation on the number of contextual trigger events that can be monitored simultaneously by ASC hardware of a device for the purposes of AI prompt generation. For example, a particular ASC hardware block may only be able to monitor for a maximum of four contextual triggers at a time (e.g., four contextual triggers, such as “human face,” “QR code,” “indoor,” and “outdoor”).

In one or more aspects, the systems and techniques provide for a solution (e.g., for ASC hardware with resource constraints) that utilizes a context trigger selection apparatus (e.g., engine), which manages the context triggers being monitored for AI prompt generation. The role of this context trigger selection apparatus (e.g., engine) is to ensure that the most applicable events in any given context are being monitored, where such designs can be based on camera sensor data directly and previous event occurrence.

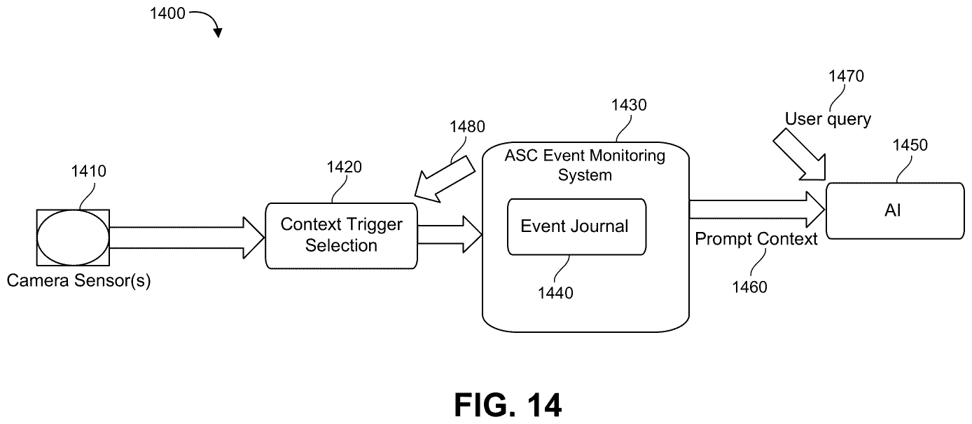

In one or more examples, context trigger selection of events may be a pre-determined hierarchical selection scheme (e.g., refer to the system 1400 of FIG. 14). For example, an “indoor” context can trigger the loading of “public” and “non-public” context triggers. For another example, the “public” context can trigger the loading of “restaurant” and “airport” context triggers. For another example, the “restaurant” context can trigger the loading of “menu” and “QR code” contexts.

FIG. 14 shows an example system for context trigger selection of events that uses a pre-determined hierarchical selection scheme. In particular, FIG. 14 is a diagram illustrating an example of a system 1400 for context trigger selection of events to be monitored by an always sensing camera (e.g., an always on camera) in a device (e.g., an XR device, such as an AR device, which may be a head-mounted device). In FIG. 14, the system 1400 is shown to include an image sensor(s) 1410 (e.g., a camera sensor, such as an ASC image sensor, for example an AON image sensor), a context trigger selection engine 1420, an ASC event monitoring engine 1430, an event journal 1440, a loopback path 1480 for images, and an AI engine 1450.

During operation of the system 1400 of FIG. 14, the image sensor(s) 1410 of the device can obtain a plurality of images of a scene. Each image of the plurality of images can be obtained at a respective time. One or more processors of the context trigger selection engine 1420 can determine, based on one or more images of the plurality of images and/or a previous event occurrence, one or more contexts for the scene. The one or more contexts can be within a hierarchical structure.

The one or more processors of the context trigger selection engine 1420 can determine, based on the one or more contexts (e.g., along with their associated hierarchical structure), one or more events. The one or more events can be stored within the event journal 1440 (e.g., a log). One or more processors of the device can load, based on the one or more events, one or more neural networks into hardware of the image sensor(s) 1410 (e.g., ASC hardware). One or more processors of the ASC event monitoring engine 1430 can command the image sensor(s) 1410 (e.g., ASC hardware) to monitor the scene for the one or more events.

The one or more processors of the ASC event monitoring engine 1430 can determine, based on the one or more events, a prompt context 1460. The device can receive a query 1470 (e.g., a user query) from a user. One or more processors of the AI engine 1450 can determine, based on the prompt context 1460 and the query 1470, an answer to the query 1470.

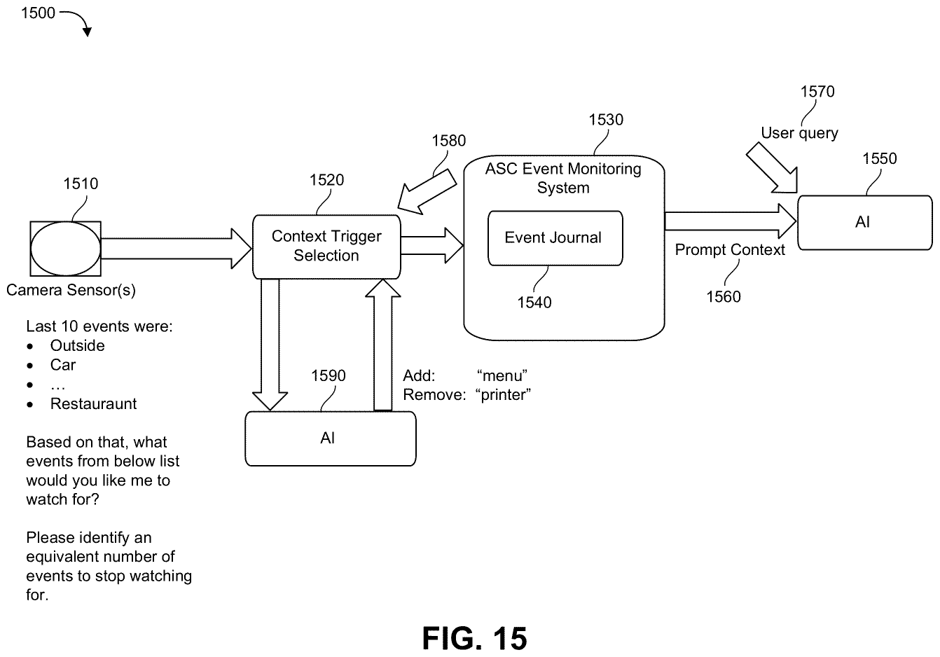

In one or more aspects, the context trigger selection of events may be sparse-map-based (e.g., performing constant feature extraction to determine whether or not to include the context in the map). In some aspects, the context trigger selection of events may be based on an LLM output itself (e.g., refer to the system 1500 of FIG. 15).

FIG. 15 shows an example system for context trigger selection of events that is based on AI (e.g., using an LLM model). The AI assistant itself may be given control of what context triggers to load or unload. In particular, FIG. 15 is a diagram illustrating an example of a system 1500 for context trigger selection of events to be monitored by an always sensing camera (e.g., an always on camera) in a device (e.g., an XR device, such as an AR device, which may be a head-mounted device), where the system 1500 uses AI to determine the events to monitor. In FIG. 15, the system 1500 is shown to include an image sensor(s) 1510 (e.g., a camera sensor, such as an ASC image sensor, for example an AON image sensor), a context trigger selection engine 1520, an AI engine 1590, an ASC event monitoring engine 1530, an event journal 1540, a loopback path 1580 for images, and an AI engine 1550.

During operation of the system 1500 of FIG. 15, the image sensor(s) 1510 of the device can obtain a plurality of images of a scene. Each image of the plurality of images can be obtained at a respective time. One or more processors of the context trigger selection engine 1520 can determine, based on one or more images of the plurality of images and/or a previous event occurrence, one or more contexts for the scene.

The one or more processors of the context trigger selection engine 1520 can determine, based on the one or more contexts, one or more events. The one or more events can be stored within the event journal 1540 (e.g., a log). One or more processors of the AI engine 1590 can determine which events to load to and which events to unload from the event journal 1540. Determining the one or more events (e.g., to be loaded or unloaded into the event journal 1540) can be further based on applying a large language model (LLM) to language of the one or more contexts.

In one or more examples, the AI engine 1590 can be associated with the device or located remote from the device. If the AI engine 1590 is local on the device, the one or more processors of the AI engine 1590 may consume significant power on the device. However, if the AI engine 1590 is hosted remotely (e.g., remote from the device), the device can request the processing by the AI engine 1590 periodically via Bluetooth with only a minimal data exchange (e.g., small amount of text) needed.

One or more processors of the device can load, based on the one or more events, one or more neural networks into hardware of the image sensor(s) 1510 (e.g., ASC hardware). One or more processors of the ASC event monitoring engine 1530 can command the image sensor(s) 1510 (e.g., ASC hardware) to monitor the scene for the one or more events.

The one or more processors of the ASC event monitoring engine 1530 can determine, based on the one or more events, a prompt context 1560. The device can receive a query 1570 (e.g., a user query) from a user. One or more processors of the AI engine 1550 can determine, based on the prompt context 1560 and the query 1570, an answer to the query 1570.

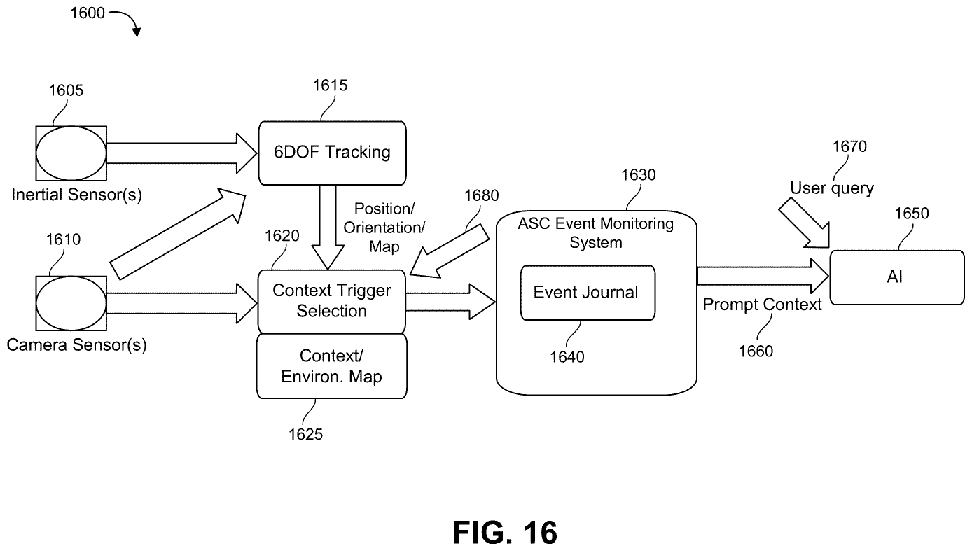

FIG. 16 shows an example system for context trigger selection of events that uses 6 DOF information. The context trigger selection can also make use of high-resolution environment maps generated by 6 DOF. In particular, FIG. 16 is a diagram illustrating an example of a system 1600 for context trigger selection of events to be monitored by an always sensing camera (e.g., an always on camera) in a device (e.g., an XR device, such as an AR device, which may be a head-mounted device), where the system 1600 uses 6 DOF tracking to determine the events to monitor. In FIG. 16, the system 1600 is shown to include an inertial sensor(s) 1605, an image sensor(s) 1610 (e.g., a camera sensor, such as an ASC image sensor, for example an AON image sensor), a 6 DOF tracking engine 1615, a context trigger selection engine 1620, an ASC event monitoring engine 1630, an event journal 1640, a loopback path 1680 for images, and an AI engine 1650.

During operation of the system 1600 of FIG. 16, the inertial sensor(s) 1605 of the device can obtain inertial data (e.g., accelerometer data and gyroscope data). The 6 DOF tracking engine 1615, based on the inertial data, can determine a position and/or orientation of the device and can update a map 1625 (e.g., context/environment map) of the physical world.

The image sensor(s) 1610 of the device can obtain a plurality of images of a scene. Each image of the plurality of images can be obtained at a respective time. One or more processors of the context trigger selection engine 1620 can determine one or more contexts for the scene based on the one or more images, the position and/or orientation of the device, and the map 1625 of the physical world.

The one or more processors of the context trigger selection engine 1620 can determine, based on the one or more contexts, one or more events. The one or more events can be stored within the event journal 1640 (e.g., a log). One or more processors of the device can load, based on the one or more events, one or more neural networks into hardware of the image sensor(s) 1610 (e.g., ASC hardware). One or more processors of the ASC event monitoring engine 1630 can command the image sensor(s) 1610 (e.g., ASC hardware) to monitor the scene for the one or more events.

The one or more processors of the ASC event monitoring engine 1630 can determine, based on the one or more events, a prompt context 1660. The device can receive a query 1670 (e.g., a user query) from a user. One or more processors of the AI engine 1650 can determine, based on the prompt context 1660 and the query 1670, an answer to the query 1670.

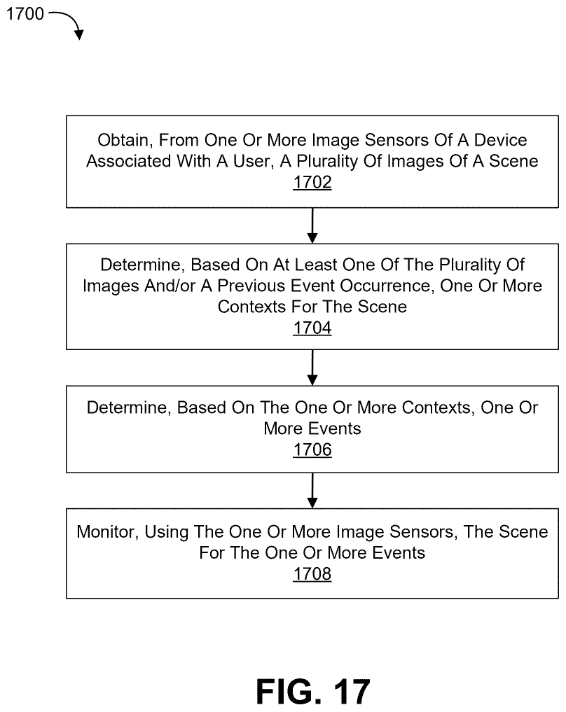

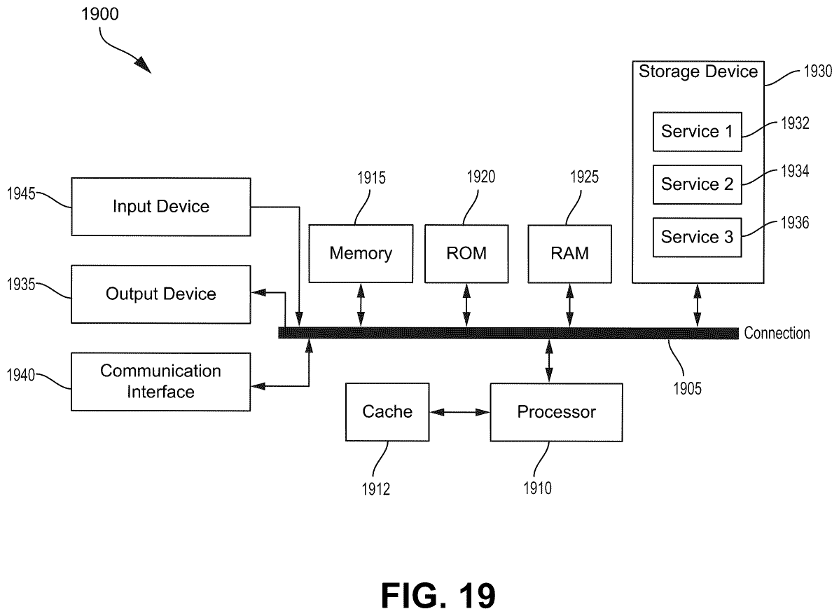

FIG. 17 is a flow chart illustrating an example of a process 1700 for AI assistance. The process 1700 can be performed by a computing device (e.g., a computing device or computing system 1900 of FIG. 19) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 1700 may be implemented as software components that are executed and run on one or more processors (e.g., processor 1910 of FIG. 19, or other processor(s)). Further, the transmission and reception of signals by the computing device in the process 1700 may be enabled, for example, by one or more antennas and/or one or more transceivers (e.g., wireless transceiver(s)).

At block 1702, the computing device (or component thereof) can obtain, from one or more image sensors of a device associated with a user, a plurality of images of a scene. In some cases, the computing device can be the device associated with the user or can be a computing system or component of the device. In some aspects, the device is an extended reality (XR) device, such as a head-mounted device. In some examples, the one or more images sensors includes one or more always-on image sensors. In some cases, each image of the plurality of images is obtained at a respective time.

At block 1704, the computing device (or component thereof) can determine, based on at least one of the plurality of images and/or a previous event occurrence, one or more contexts for the scene. In some aspects, the one or more contexts are in a hierarchical structure.

At block 1706, the computing device (or component thereof) can determine, based on the one or more contexts, one or more events. In some aspects, the computing device (or component thereof) can store the one or more events in a log. In some cases, the computing device (or component thereof) can determine the one or more events further based on a map including the one or more contexts. In some examples, the computing device (or component thereof) can determine the one or more events further based on applying a large language model (LLM) to language of the one or more contexts. In some aspects, the computing device (or component thereof) can determine the one or more events further based on a respective six degrees of freedom (DOF) of each image sensor of the one or more image sensors when obtaining the one or more images of the plurality of images. In some cases, the one or more events are determined by at least one processor of the computing device or by one or more processors located remote from the device.

At block 1708, the computing device (or component thereof) can monitor, by the one or more image sensors, the scene for the one or more events. In some aspects, the computing device (or component thereof) can load, based on the one or more events, one or more neural network models into hardware of the one or more image sensors. In some aspects, the computing device (or component thereof) can determine, based on the one or more events, a prompt context. In some cases, the computing device (or component thereof) can receive a query from a user. In some examples, the computing device (or component thereof) can determine, based on the prompt context and the query, an answer to the query.

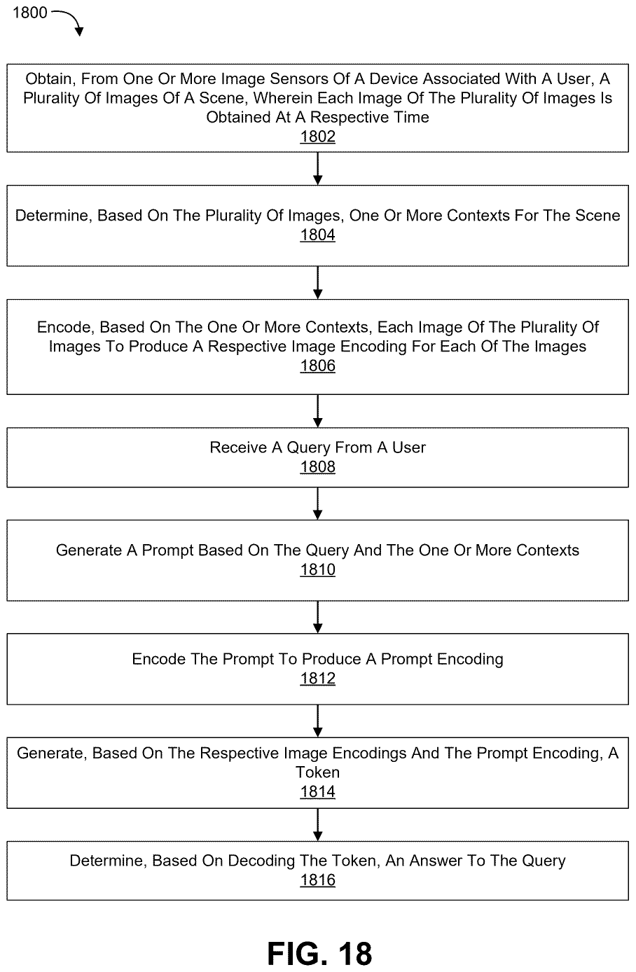

FIG. 18 is a flow chart illustrating an example of a process 1800 for AI assistance. The process 1800 can be performed by a computing device (e.g., a computing device or computing system 1900 of FIG. 19) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 1800 may be implemented as software components that are executed and run on one or more processors (e.g., processor 1910 of FIG. 19, or other processor(s)). Further, the transmission and reception of signals by the computing device in the process 1800 may be enabled, for example, by one or more antennas and/or one or more transceivers (e.g., wireless transceiver(s)).

At block 1802, the computing device (or component thereof) can obtain, from one or more image sensors of a device associated with a user, a plurality of images of a scene. Each image of the plurality of images is obtained at a respective time. In some aspects, the computing device can be the device associated with the user or can be a computing system or component of the device. In some cases, the device is an extended reality (XR) device, such as a head-mounted device. In some aspects, the one or more images sensors includes one or more always-on image sensors.

At block 1804, the computing device (or component thereof) can determine, based on the plurality of images, one or more contexts for the scene. In some aspects, the computing device (or component thereof) can store the one or more contexts within a log (e.g., a vector database or other type of log). In some cases, the computing device (or component thereof) can remove at least one context of the one or more contexts from the log based on an expiration of time from obtaining at least one image of the plurality of images associated with the at least one context.

At block 1806, the computing device (or component thereof) can encode, based on the one or more contexts, each image of the plurality of images to produce a respective image encoding for each of the plurality of images.

At block 1808, the computing device (or component thereof) can receive a query from the user. In some aspects, the computing device (or component thereof) can obtain the plurality of images and produce the respective image encodings of each image of the plurality of images prior to receiving the query.

At block 1810, the computing device (or component thereof) can generate a prompt based on the query and the one or more contexts. In some aspects, the computing device (or component thereof) can generate, based on the prompt, a prompt embedding. In some cases, the computing device (or component thereof) can perform, based on the prompt embedding, a vector search within the vector database to determine event information. In some examples, the computing device (or component thereof) can add the event information to the prompt.

At block 1812, the computing device (or component thereof) can encode the prompt to produce a prompt encoding.

At block 1814, the computing device (or component thereof) can generate, based on the respective image encodings and the prompt encoding, a token.

At block 1816, the computing device (or component thereof) can determine, based on decoding the token, an answer to the query. In some aspects, the computing device (or component thereof) can determine the answer to the query further based on language within the query. In some cases, the computing device (or component thereof) can determine the answer to the query further based on applying the language within the query to a large language model (LLM).

In some cases, the computing device of process 1700 and process 1800 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1700 and process 1800 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1700 and process 1800 is each illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1700 and process 1800 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 19 is a block diagram illustrating an example of a computing system 1900, which may be employed for low power camera sensing for AI assistance. In particular, FIG. 19 illustrates an example of computing system 1900, which can be for example any computing device making up internal computing system, a remote computing system, a camera, or any component thereof in which the components of the system are in communication with each other using connection 1905. Connection 1905 can be a physical connection using a bus, or a direct connection into processor 1910, such as in a chipset architecture. Connection 1905 can also be a virtual connection, networked connection, or logical connection.

In some aspects, computing system 1900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1900 includes at least one processing unit (CPU or processor) 1910 and connection 1905 that communicatively couples various system components including system memory 1915, such as read-only memory (ROM) 1920 and random access memory (RAM) 1925 to processor 1910. Computing system 1900 can include a cache 1912 of high-speed memory connected directly with, in close proximity to, or integrated as part of processor 1910.

Processor 1910 can include any general purpose processor and a hardware service or software service, such as services 1932, 1934, and 1936 stored in storage device 1930, configured to control processor 1910 as well as a special-purpose processor where software instructions are incorporated into the actual processor design. Processor 1910 may essentially be a completely self-contained computing system, containing multiple cores or processors, a bus, memory controller, cache, etc. A multi-core processor may be symmetric or asymmetric.

To enable user interaction, computing system 1900 includes an input device 1945, which can represent any number of input mechanisms, such as a microphone for speech, a touch-sensitive screen for gesture or graphical input, keyboard, mouse, motion input, speech, etc. Computing system 1900 can also include output device 1935, which can be one or more of a number of output mechanisms. In some instances, multimodal systems can enable a user to provide multiple types of input/output to communicate with computing system 1900.

Computing system 1900 can include communications interface 1940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1940 may also include one or more range sensors (e.g., LiDAR sensors, laser range finders, RF radars, ultrasonic sensors, and infrared (IR) sensors) configured to collect data and provide measurements to processor 1910, whereby processor 1910 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1940 may also include one or more receivers or transceivers that are used to determine a location of the computing system 1900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1930 can include software services, servers, services, etc., that when the code that defines such software is executed by the processor 1910, it causes the system to perform a function. In some aspects, a hardware service that performs a particular function can include the software component stored in a computer-readable medium in connection with the necessary hardware components, such as processor 1910, connection 1905, output device 1935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for artificial intelligence (AI) assistance, the apparatus comprising: at least one memory; and at least one processor coupled to the at least one memory and configured to: obtain, from one or more image sensors of a device associated with a user, a plurality of images of a scene; determine, based on at least one of the plurality of images or a previous event occurrence, one or more contexts for the scene; determine, based on the one or more contexts, one or more events; and monitor, using the one or more image sensors, the scene for the one or more events.

Aspect 2. The apparatus of Aspect 1, wherein the at least one processor is configured to store the one or more events in a log.

Aspect 3. The apparatus of any of Aspects 1 or 2, wherein the at least one processor is configured to load, based on the one or more events, one or more neural network models into hardware of the one or more image sensors.

Aspect 4. The apparatus of any of Aspects 1 to 3, wherein each image of the plurality of images is obtained at a respective time.

Aspect 5. The apparatus of any of Aspects 1 to 4, wherein the one or more contexts are in a hierarchical structure.

Aspect 6. The apparatus of any of Aspects 1 to 5, wherein the at least one processor is configured to determine the one or more events further based on a map comprising the one or more contexts.

Aspect 7. The apparatus of any of Aspects 1 to 6, wherein the at least one processor is configured to determine the one or more events further based on applying a large language model (LLM) to language of the one or more contexts.

Aspect 8. The apparatus of Aspect 7, wherein the one or more events are determined by the at least one processor of the apparatus or by one or more processors located remote from the device.

Aspect 9. The apparatus of any of Aspects 1 to 8, wherein the at least one processor is configured to determine the one or more events further based on a respective six degrees of freedom (DOF) of each image sensor of the one or more image sensors when obtaining the one or more images of the plurality of images.

Aspect 10. The apparatus of any of Aspects 1 to 9, wherein the at least one processor is configured to determine, based on the one or more events, a prompt context.

Aspect 11. The apparatus of Aspect 10, wherein the at least one processor is configured to receive a query from a user.

Aspect 12. The apparatus of Aspect 11, wherein the at least one processor is configured to determine, based on the prompt context and the query, an answer to the query.

Aspect 13. The apparatus of any of Aspects 1 to 12, wherein the one or more images sensors includes one or more always-on image sensors.

Aspect 14. An apparatus for artificial intelligence (AI) assistance, the apparatus comprising: at least one memory; and at least one processor coupled to the at least one memory and configured to: obtain, from one or more image sensors of a device associated with a user, a plurality of images of a scene, wherein each image of the plurality of images is obtained at a respective time; determine, based on the plurality of images, one or more contexts for the scene; encode, based on the one or more contexts, each image of the plurality of images to produce a respective image encoding for each of the plurality of images; receive a query from the user; generate a prompt based on the query and the one or more contexts; encode the prompt to produce a prompt encoding; generate, based on the respective image encodings and the prompt encoding, a token; and determine, based on decoding the token, an answer to the query.

Aspect 15. The apparatus of Aspect 14, wherein the at least one processor is configured to obtain the plurality of images and produce the respective image encodings of each image of the plurality of images prior to receiving the query.

Aspect 16. The apparatus of any of Aspects 14 or 15, wherein the at least one processor is configured to determine the answer to the query further based on language within the query.

Aspect 17. The apparatus of Aspect 16, wherein the at least one processor is configured to determine the answer to the query further based on applying the language within the query to a large language model (LLM).

Aspect 18. The apparatus of any of Aspects 14 to 17, wherein the at least one processor is configured to store the one or more contexts within a log.

Aspect 19. The apparatus of Aspect 18, wherein the at least one processor is configured to remove at least one context of the one or more contexts from the log based on an expiration of time from obtaining at least one image of the plurality of images associated with the at least one context.

Aspect 20. The apparatus of any of Aspects 18 or 19, wherein the log is a vector database.

Aspect 21. The apparatus of Aspect 20, wherein the at least one processor is configured to generate, based on the prompt, a prompt embedding.

Aspect 22. The apparatus of Aspect 21, wherein the at least one processor is configured to perform, based on the prompt embedding, a vector search within the vector database to determine event information.

Aspect 23. The apparatus of Aspect 22, wherein the at least one processor is configured to add the event information to the prompt.

Aspect 24. The apparatus of any of Aspects 14 to 23, wherein the device is an extended reality (XR) device.

Aspect 25. The apparatus of any of Aspects 14 to 24, wherein the device is a head-mounted device.

Aspect 26. The apparatus of any of Aspects 14 to 25, wherein the one or more images sensors includes one or more always-on image sensors.

Aspect 27. A method for artificial intelligence (AI) assistance, the method comprising: obtaining, by one or more image sensors of a device associated with a user, a plurality of images of a scene; determining, based on at least one of the plurality of images or a previous event occurrence, one or more contexts for the scene; determining, based on the one or more contexts, one or more events; and monitoring, by the one or more image sensors, the scene for the one or more events.

Aspect 28. The method of Aspect 27, further comprising storing the one or more events in a log.

Aspect 29. The method of any of Aspects 27 or 28, further comprising loading, based on the one or more events, one or more neural network models into hardware of the one or more image sensors.

Aspect 30. The method of any of Aspects 27 to 29, wherein each image of the plurality of images is obtained at a respective time.

Aspect 31. The method of any of Aspects 27 to 30, wherein the one or more contexts are in a hierarchical structure.

Aspect 32. The method of any of Aspects 27 to 31, wherein determining the one or more events is further based on a map comprising the one or more contexts.

Aspect 33. The method of any of Aspects 27 to 32, wherein determining the one or more events is further based on applying a large language model (LLM) to language of the one or more contexts.

Aspect 34. The method of Aspect 33, wherein the one or more events are determined by one or more processors associated with the device or located remote from the device.

Aspect 35. The method of any of Aspects 27 to 34, wherein determining the one or more events is further based on a respective six degrees of freedom (DOF) of each image sensor of the one or more image sensors when obtaining the one or more images of the plurality of images.

Aspect 36. The method of any of Aspects 27 to 35, further comprising determining, based on the one or more events, a prompt context.

Aspect 37. The method of Aspect 36, further comprising receiving a query from a user.

Aspect 38. The method of Aspect 37, further comprising determining, based on the prompt context and the query, an answer to the query.

Aspect 39. The method of any of Aspects 27 to 38, wherein the one or more images sensors includes one or more always-on image sensors.

Aspect 40. A method for artificial intelligence (AI) assistance, the method comprising: obtaining, by one or more image sensors of a device associated with a user, a plurality of images of a scene, wherein each image of the plurality of images is obtained at a respective time; determining, by one or more processors of the device based on the plurality of images, one or more contexts for the scene; encoding, by the one or more processors based on the one or more contexts, each image of the plurality of images to produce a respective image encoding for each of the plurality of images; receiving, by the one or more processors, a query from the user; generating, by the one or more processors, a prompt based on the query and the one or more contexts; encoding, by the one or more processors, the prompt to produce a prompt encoding; generating, by the one or more processors based on the respective image encodings and the prompt encoding, a token; and determining, by the one or more processors based on decoding the token, an answer to the query.

Aspect 41. The method of Aspect 40, wherein obtaining the plurality of images and producing the respective image encodings of each image of the plurality of images occur prior to receiving the query.

Aspect 42. The method of any of Aspects 40 or 41, wherein determining the answer to the query is further based on language within the query.

Aspect 43. The method of Aspect 42, wherein determining the answer to the query is further based on applying the language within the query to a large language model (LLM).

Aspect 44. The method of any of Aspects 40 to 43, further comprising storing the one or more contexts within a log.

Aspect 45. The method of Aspect 44, further comprising removing, by the one or more processors, at least one context of the one or more contexts from the log based on an expiration of time from obtaining at least one image of the plurality of images associated with the at least one context.

Aspect 46. The method of any of Aspects 44 or 45, wherein the log is a vector database.

Aspect 47. The method of Aspect 46, further comprising generating, by the one or more processors based on the prompt, a prompt embedding.

Aspect 48. The method of Aspect 47, further comprising performing, by the one or more processors based on the prompt embedding, a vector search within the vector database to determine event information.

Aspect 49. The method of Aspect 48, further comprising adding, by the one or more processors, the event information to the prompt.

Aspect 50. The method of any of Aspects 40 to 49, wherein the device is an extended reality (XR) device.

Aspect 51. The method of any of Aspects 40 to 50, wherein the device is a head-mounted device.

Aspect 52. The method of any of Aspects 40 to 51, wherein the one or more images sensors includes one or more always-on image sensors.

Aspect 53. A non-transitory computer-readable medium having stored thereon instructions that, when executed by at least one processor, cause the at least one processor to perform operations according to any of Aspects 27 to 39.

Aspect 54. An apparatus for AI assistance, the apparatus including one or more means for performing operations according to any of Aspects 27 to 39.

Aspect 55. A non-transitory computer-readable medium having stored thereon instructions that, when executed by at least one processor, cause the at least one processor to perform operations according to any of Aspects 40 to 52.

Aspect 56. An apparatus for AI assistance, the apparatus including one or more means for performing operations according to any of Aspects 40 to 52.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for artificial intelligence (AI) assistance, the apparatus comprising:
at least one memory; and
at least one processor coupled to the at least one memory and configured to:
obtain, from one or more image sensors of a device associated with a user, a plurality of images of a scene;
determine, based on at least one of the plurality of images or a previous event occurrence, one or more contexts for the scene;
determine, based on the one or more contexts, one or more events; and
monitor, using the one or more image sensors, the scene for the one or more events.

2. The apparatus of claim 1, wherein the at least one processor is configured to store the one or more events in a log.

3. The apparatus of claim 1, wherein the at least one processor is configured to load, based on the one or more events, one or more neural network models into hardware of the one or more image sensors.

4. The apparatus of claim 1, wherein each image of the plurality of images is obtained at a respective time.

5. The apparatus of claim 1, wherein the one or more contexts are in a hierarchical structure.

6. The apparatus of claim 1, wherein the at least one processor is configured to determine the one or more events further based on a map comprising the one or more contexts.

7. The apparatus of claim 1, wherein the at least one processor is configured to determine the one or more events further based on applying a large language model (LLM) to language of the one or more contexts.

8. The apparatus of claim 7, wherein the one or more events are determined by the at least one processor of the apparatus or by one or more processors located remote from the device.

9. The apparatus of claim 1, wherein the at least one processor is configured to determine the one or more events further based on a respective six degrees of freedom (DOF) of each image sensor of the one or more image sensors when obtaining the one or more images of the plurality of images.

10. The apparatus of claim 1, wherein the at least one processor is configured to determine, based on the one or more events, a prompt context.

11. The apparatus of claim 10, wherein the at least one processor is configured to receive a query from a user.

12. The apparatus of claim 11, wherein the at least one processor is configured to determine, based on the prompt context and the query, an answer to the query.

13. The apparatus of claim 1, wherein the one or more images sensors includes one or more always-on image sensors.

14. An apparatus for artificial intelligence (AI) assistance, the apparatus comprising:
at least one memory; and
at least one processor coupled to the at least one memory and configured to:
obtain, from one or more image sensors of a device associated with a user, a plurality of images of a scene, wherein each image of the plurality of images is obtained at a respective time;
determine, based on the plurality of images, one or more contexts for the scene;
encode, based on the one or more contexts, each image of the plurality of images to produce a respective image encoding for each of the plurality of images;
receive a query from the user;
generate a prompt based on the query and the one or more contexts;
encode the prompt to produce a prompt encoding;
generate, based on the respective image encodings and the prompt encoding, a token; and
determine, based on decoding the token, an answer to the query.

15. The apparatus of claim 14, wherein the at least one processor is configured to obtain the plurality of images and produce the respective image encodings of each image of the plurality of images prior to receiving the query.

16. The apparatus of claim 14, wherein the at least one processor is configured to determine the answer to the query further based on language within the query.

17. The apparatus of claim 16, wherein the at least one processor is configured to determine the answer to the query further based on applying the language within the query to a large language model (LLM).

18. The apparatus of claim 14, wherein the at least one processor is configured to store the one or more contexts within a log.

19. The apparatus of claim 18, wherein the at least one processor is configured to remove at least one context of the one or more contexts from the log based on an expiration of time from obtaining at least one image of the plurality of images associated with the at least one context.

20. The apparatus of claim 18, wherein the log is a vector database.
